(19) United States
(12) Patent Application Publication
(10) Pub. No.: US 2004/0068458 A1
(43) Pub. Date: Apr. 8, 2004

(54) Pocket rocket

(76) Inventor: Michael Allen Russo, Warwick, RI (US)

Correspondence Address: Michael Allen Russo, PO BOX 9323, Warwick, RI, 02889, US

(21) Appl. No.: 10/420,073

(22) Filed: Apr. 21, 2003

Related U.S. Application Data
(60) Provisional application No. 60/374,604, filed on Apr. 23, 2002.

(51) Int. Cl. G06F 17/60

(52) U.S. Cl. 705/36

(57) ABSTRACT

A virtual stock market that fits in the “user” of the machine's pocket. Three U.S. Stock Exchanges, the NYSE, the NASDAQ and the AMEX embedded within Six types of Stock Market Ticker Tape Formatted Displays along with Twenty three Multiple catagory, Three Second Formatted Displays depicting around the clock, live, real time, Eastern time and reiterated dormant, world-wide economic data onto the viewing screen of a mobile, hand-held, wireless device that is small enough to fit into the “user” of the machine's pocket ie the stock market in your pocket.

The title of the invention says it all, yet for disclosure purposes I will elaborate. The machine is a mobile hand-held, wireless, digital radio transmitter/receiver that enables the “user” of the machine the ability, the means and the convenience of having around the clock access to the daily listings of company stock symbols listed with Three U.S. Stock Exchanges, the NYSE and or the New York Stock Exchange along with the NASDAQ and or the NASDAQ Stock Exchange and the Third of Three exchanges, the AMEX and or the American Stock Exchange. Each of the exchange listed stock symbols along with the symbol's per share price and the daily gain and or loss realized and or suffered during the present day's trading, will be depicted live and or in real time prices during normal Market hours. During the after Market hours session the pm 4:00 est. time Closing bell prices will be depicted and reiterated until such time as when the Markets Once again open for the business of trading shares of listed company's stock and or until such time as the beginning of the next Market session. The machine depicts and or displays Six types of color-coded stock market ticker tapes, Four at a time, onto the viewing screen of a machine small enough to fit into the “user” of the machine's pocket. The machine depicts live, real time and or dormant economic data, Twenty Four hours of each day, Seven days of each week, from now till ever after.

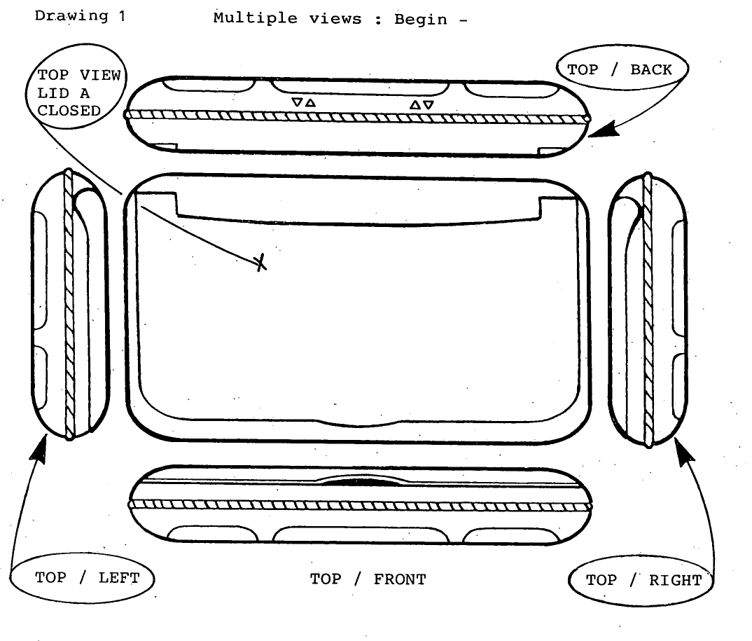

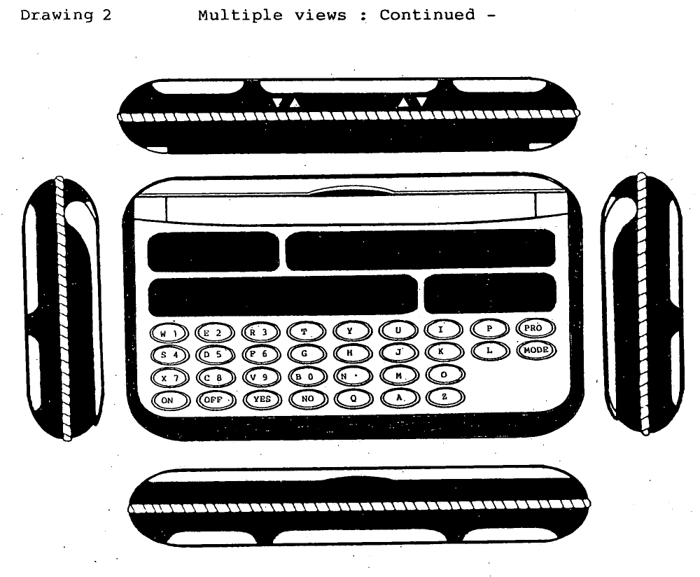

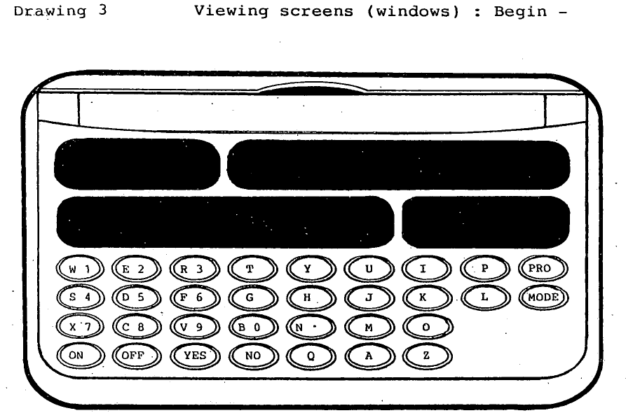

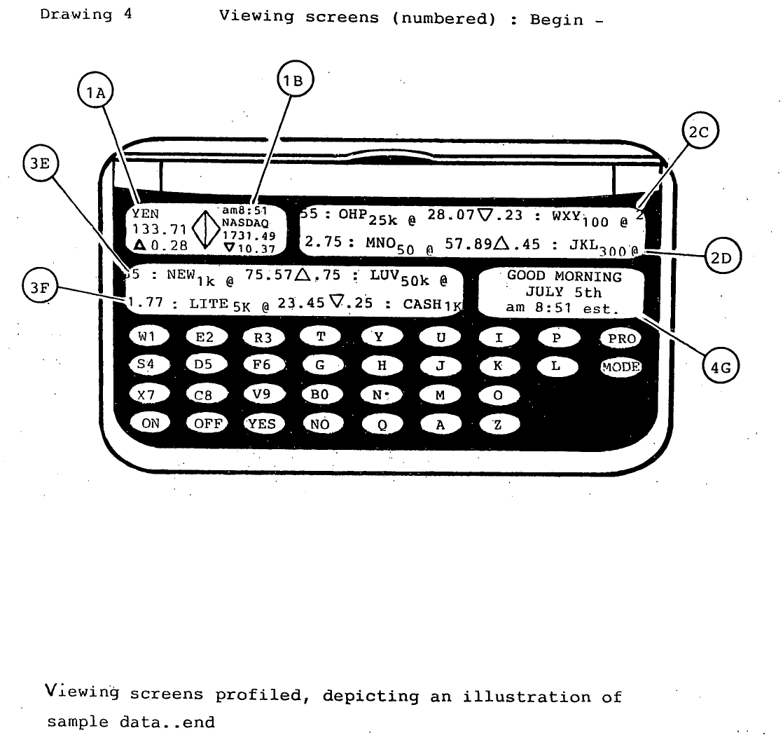

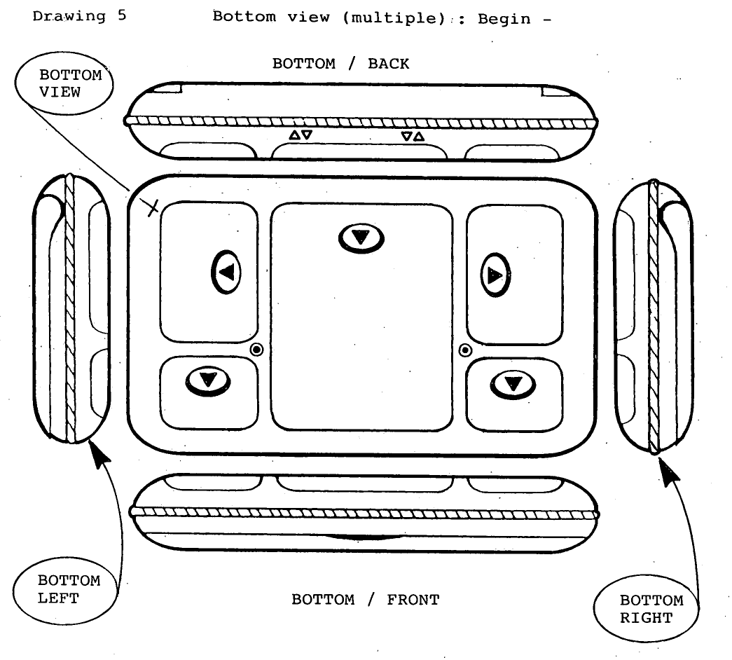

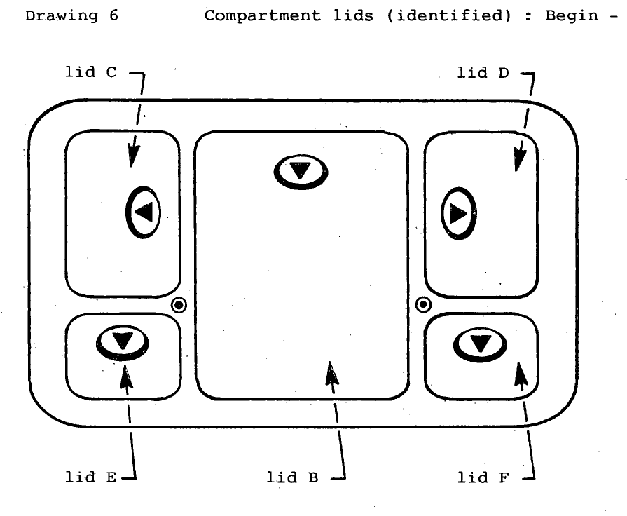

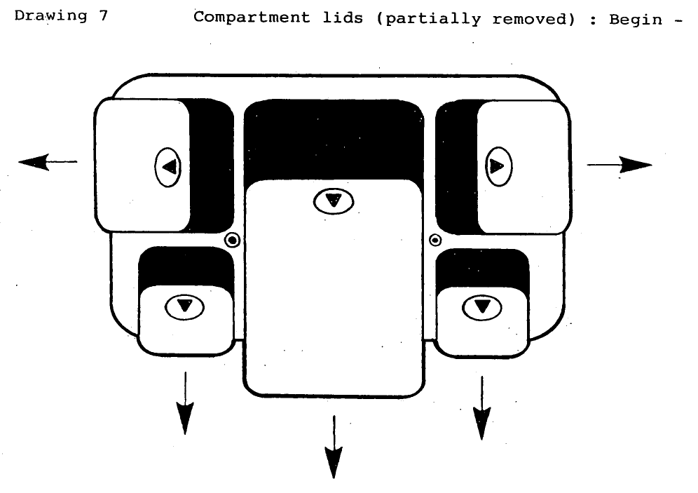

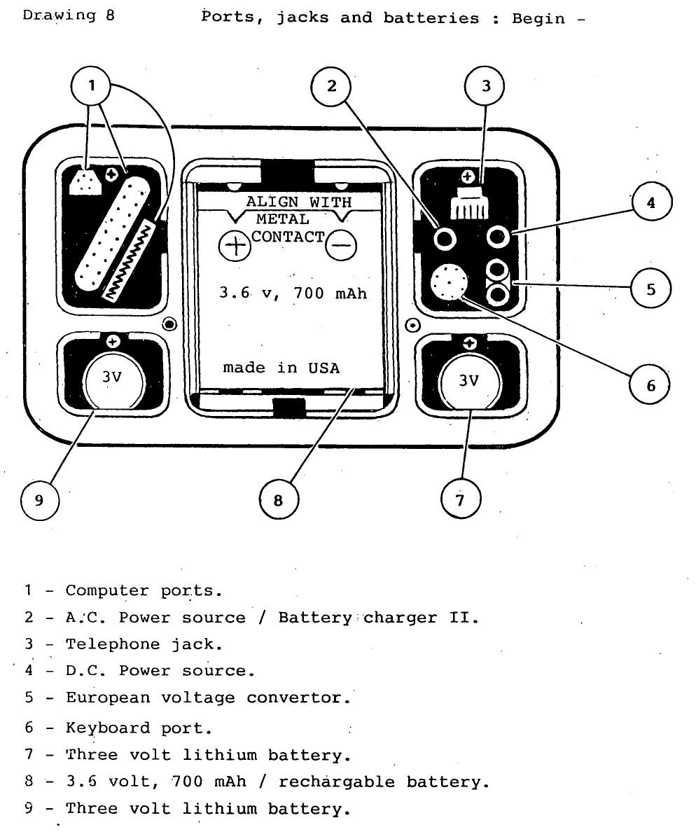

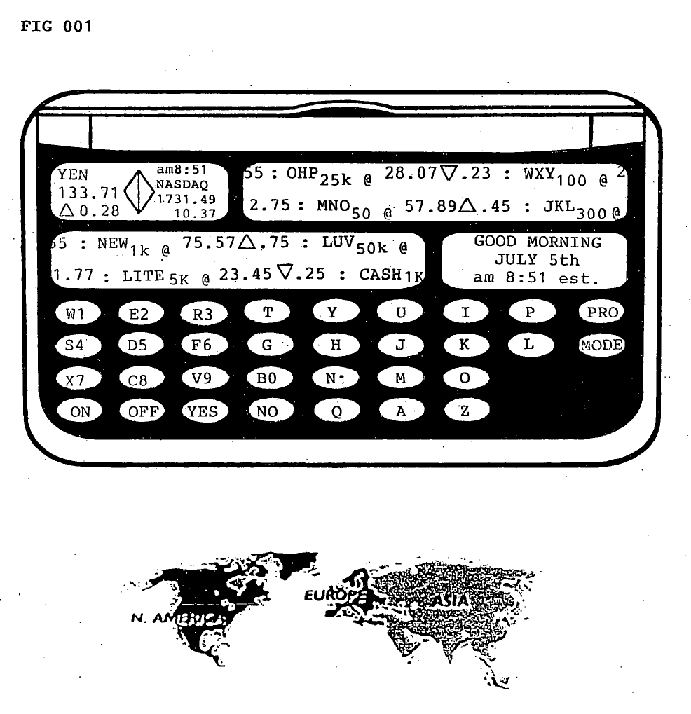

Included are Eight drawings depicting the shape and ornamental design of the machine. The machine is Thirteen centimeters long, Seven point Five centimeters wide and Two point Two centimeters thick. The container's shell and or skin is comprised of 0.1 centimeter thick stainless steel with a braided Fourteen guage copper wire encompassing the perimeter. The view screens and or windows are comprised of plexiglass and the keyboard keys are plastic. (SPECIAL NOTE), directly following Drawing 8 of 8 are the newly named Flow Diagrams and or FIG's that were once embedded within the schematic. In compliance with the Patent Office's rules and regulations concerning Patent application formats the said mentioned Flow Diagrams and or FIG's have been consolidated to elimanate redundant reiteration, the FIG's have been re-numbered in chronological order, the FIG's have been redone and or illustrated using Indian Ink and all letters and or words are mechanically fonted. These said mentioned Flow diagrams and or FIGS. 1-108 are now located and or can be viewed-on pages 96-129 of this manuscript.

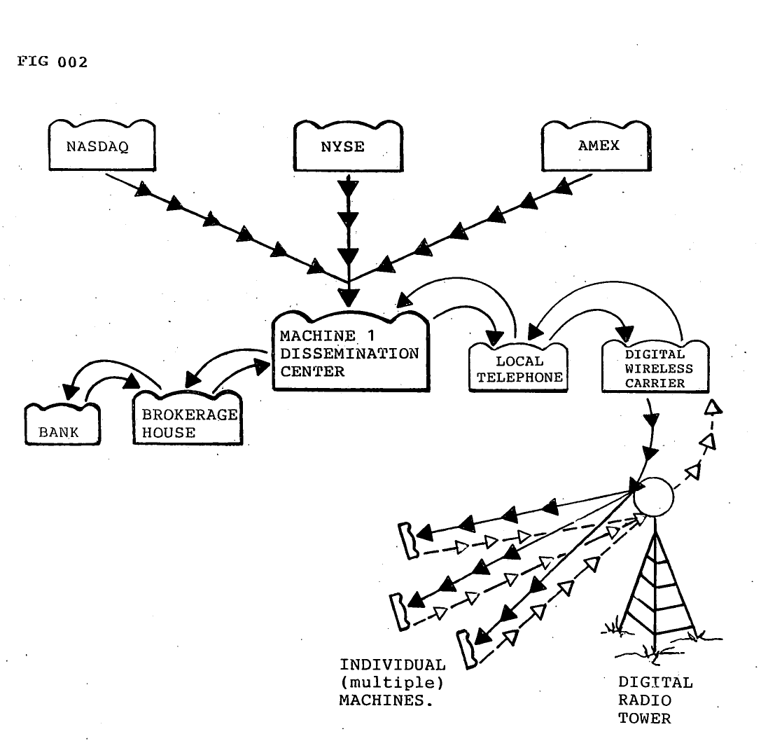

The physical description of the machine is a stainless steel container measuring Thirteen centimeters long, Seven point Five centimeters wide and Two point Two centimeters thick. The machine has Thirty Two keyboard keys, thirteen of which are dual and or multi-functional keys. The machine has One viewing screen divided into Four windows, Three of the windows depict split screen and or dual action, the Fourth window is the “user” of the machine's interface. The machine has the capabilities of simultaneous depiction of world-wide economic data venued through Four stock market ticker tapes, these Four venues can depict any One of Six types of stock. market ticker tapes. The machine has the capabilities of simultaneous depiction of world-wide economic data venued through Two and or dual multiple catagory formatted displays, these Two venues are depicted within One of Four of the machine's windows onto a split screen that depicts Twenty Three indexs rotating within Two seperate simultaneously depicted rotation orders. The machine has Four modes of operation and can be programmed in any One of Three languages, English, French and or Spanish. The machine introduces Two unique services, the First of which is, the machine enables the “user” of the machine the ability, the means and the convenience to extract, depict and monitor Three U.S. Stock Exchanges, the NYSE and or the New York Stock Exchange, the NASDAQ and or the NASDAQ Stock Exchange and the AMEX and or the American Stock Exchange's listed stock symbols onto and or embedded within Six types of stock market ticker tape formatted displays, Four at a time in both live and or real time and or dormant after Market hours stock prices, around the clock and or Twenty Four hours of each day, Seven days of each week, now and ever after onto the machine's viewing screen. The Second of Two unique services provided, the machine enables the “user” of the machine the ability, the means and the convenience to track, trade and set limit orders with the Top Six Hundred companies, (according to Market Capitalization), listed daily with any One and or each of the Three said mentioned U.S. Stock Exchanges and or the NYSE, the NASDAQ and the AMEX from anywhere within the realm of the world wide telecommunications network via wireless, digital radio waves, signals and or transmissions to and from the mobile, hand-held, wireless, digital radio transmitter/receiver and or the machine. Technologically speaking the process is as follows, their are Four points of connection. The First of Four is the Machine 1 dissemination center. The second of Four is a contracted internationally recognized Brokerage House. The Third of Four is a Money Market fund manager who works directly with the said mentioned Brokerage House. The Fourth of Four is the multiple, individual machines. The process is as follows, the machine communicates with the dissemination center's mainframe, computer servers. These said mentioned computer servers communicate with the Brokerage House's. mainframe computer servers wich are also connected to the Money Market fund manager's mainframe, computer servers. Once the transaction is complete the Brokerage House's mainframe computer servers communicate with the dissemination center's mainframe computer servers which in return communicate with the multiple, individual machines. For a detailed explanatory of the machine 1 and or the machine's process see the following flow diagram and or FIG, (SEE FIG. 002).

The machine sends a signal via wireless, digital radio technology to a Brick and Mortar structure called (for disclosure purposes) the Machine 1 Dissemination Center. Housed within the Center is a mainframe computer server equiped with a search engine. This computer server is linked to a telecommunications network interface and or a Multiplexor with Burst technologies. This Multiplexor is linked via a T3 connector to a Fiber Optic hard and or land line telecommunications network system. The Dissemination Center is linked to Five distinct entities. First and foremost are the links between the Three U.S. Stock Exchange's contracted dispersed data services to the Dissemination Center. This said mentioned contracted service provides the economic data by and or for the multiple, individual machines. The Fourth hard and or land line connection is to and from a contracted Federally regulated and insured international Brokerage House. The Brokerage firm manages both the “user” of the machine's Stock Portfolio Account and oversees and maintains the “user” of the machine's Money Market Account held and or housed within a Bank and or a Financial Institution. The Fifth link is to and from a National, wireless carrier for the transmission and reception of digital radio waves, comprised of extracted economic data in Burst form. This Burst of economic data is sent via Fiber Optic hard and or land lines to and through the local telephone company. The local Telephone Company transfers the Burst to a contracted, National, wireless carrier. The Wireless Carrier transmitts the Burst of data via a network of Digital Radio Towers. This concludes the process for receiving the main body of predetermined economic data deemed necessary by and or for the machine's normal modes of operation. As far as interaction and or when the machine's Portfolio feature is activated a Second signal is sent to the Dissemination Center's mainframe computer servers via digital radio waves and or technology. This Second signal directs the Center's search engine, to place the appropriate stock order with the Brokerage and or Stock Clearing house via Fiber Optic hard and or land lines. The Broker trades (buys and or sells) shares of stocks with any One of Three U.S. Stock Exchanges for the “user” of the machine. The Brokerage Firm manages both the “user” of the machine's Stock Portfolio and Money Market Accounts. Once the Broker executes the trade, the Brokerage House's mainframe computer server signals the Dissemination Center's mainframe computer server via Fiber Optic hard and or land lines. The Center's search engine signals the machine via digital radio technology of the completed transaction. This is the process from which normal modes of operation of the machine are realized.

The Machine 1 and or the machine depicts Six types of SMTTFD and or Six types of Stock Market Ticker Tape Formatted Displays and or SMTTFD types One through Six. This is the description of a Stock Market Ticker tape Formatted Display type 1 and or a SMTTFD type 1 and or a type 1. A SMTTFD type 1 is a live, real time, depicted as listed, live trades, stock market ticker tape formatted display. Note, during Market Hours and or from a.m. 9:30 est. time Opening Bell through and or until p.m. 4:00 est. time Closing Bell, Fifteen Thousand Six hundred Live Trades (buy and or sell trades) will-be depicted as listed on this SMTTFD type 1.

A SMTTFD type 1 has Six fields of economic data depicted and or embedded within a String Format and or as a String of characters processed as a unit. The First of Six and or field One of Six is a character field that depicts any of the Exchange Listed company acronyms and or stock symbols in a random, depicted as listed rotation order. These said mentioned company acronyms and or stock symbols are comprised of and or made up of from as few as One to as many as Six characters and or letters. Each company listed with the depicted stock exchange is assigned a character specific acronym and or stock symbol. These stock symbols will be listed here in Field One of Six and or within this character field.

The Second of Six and or Field Two of Six is a Number Field that depicts the numerical value equivalent to how many shares of the depicted stock symbol that has been bought and or sold. This Number Field and or this numerical value is displayed in subscript and therefore shall be depicted below the baseline of the body of text.

The Third of Six and or Field Three of Six is a Second and or another Character Field that depicts a Single character and or symbol representative of the word (at) and or the universal (@) symbol. This Second of Two Character Fields and or Field Three of Six is also depicted in subscript and therefore shall be depicted below the baseline of the body of text. This Second Character Field and or Field Three of Six is directly associated with the numerical value depicted in the Number Field and or Field Two of Six and shall therefore appear and or be depicted adjoined to and or directly following the said mentioned numerical value. This Second of Two Character Fields and or Field Three of Six and or the symbol (@), is an indication to the “user” of the machine that X ammount and or the numerical value in the Number Field and or in Field Two of Six has been bought and or sold (@) the monetary value and or price depicted in Field Four of Six and or within the Second of Three Number Fields.

The Fourth of Six and or Field Four of Six is the Second of Three Number Fields, this field depicts the purchase and or sale price of One share of the depicted company's stock. Field Four of Six depicts Four numerical characters and or numbers, then a decimal point followed by Two more numerical characters and or numbers.

The Fifth of Six and or Field Five of Six is a Logic Field represented by a symbol that indicates the provision of Two choices. The First of Two choices offered within Field Five of Six and or the Logic Field is an upright positioned pyramid shaped symbol. When this pyramid shaped symbol appears and or is depicted within an upright position, this is an indication to the “user” of the machine that all of the economic data pertaining to the depicted stock symbol and or all of the data embedded within the entire String of characters is presently trading higher and or is up and or is realizing a gain in overall monetary value since such time as the Opening Bell prices were posted at the beginning of the present ongoing Market Session. When this upright positioned pyramid shaped symbol appears and or is depicted, all of the economic data within the entire String of characters will be shown, displayed and or depicted in the color of Green.

The Second of Two choices offered within Field Five of Six and or the Logic Field is an inverted and or an upside down positioned pyramid shaped symbol. When this pyramid shaped symbol appears and or is depicted in an inverted and or in an upside down position, this is an indication to the “user” of the machine, that all of the economic data pertaining to the particular stock symbol and or all of the data embedded within the entire String of characters is presently trading lower and or is down and or is suffering a loss in overall monetary value since such time as the Opening Bell prices were posted at the beginning of the present ongoing Market Session. When this inverted and or this upside down positioned pyramid shaped symbol appears and or is depicted all of the economic data embedded within the entire String of characters will be shown, displayed and or depicted in the color of Red.

The Sixth of Six fields and or Field Six of Six is the Third of Three Number Fields. Field Six of Six depicts the monetary value equivalent to the daily gain and or loss realized and or suffered by the depicted company and or the depicted stock symbol's per share price since such time as the beginning of the day and or since the a.m. 9:30 est. time

Opening Bell of this Present Day and or this Ongoing Live Market Session.

These Six fields of economic data and or fields One through Six are formatted and or depicted embedded within a String of characters that scroll from the Right side of the machine's viewing screen to the Left side of the screen. These Six said mentioned fields and or this entire String of characters will be shown, depicted and or displayed at a rate and or a speed equivalent to Eight Hundred Eighty character fonts per Minute and or Twenty Two character fonts per One point Five Seconds of viewing and or display time. The Exchange listed stock symbols are depicted in a random, First come, First serve basis and or in a depicted as listed, live trades rotation cycle. All Number and Logic Fields depict the present day, live, real time, Eastern time prices.

A SMTTFD type 1 will be shown and or depicted embedded with scalable fonts, with each character occupying the same and or equal space. Each Field will be seperated One from the other by the width of One scalable font, this font space will remain and or be depicted blank. These blank spaces and or spacer fonts will be utilized for visual seperation and or as a perception aid.

The Machine 1 and or the machine depicts Six types of SMTTFD and or six types of Stock Market Ticker Tape Formatted Displays and or SMTTFD types One through Six. This is the description of a Stock Market Ticker Tape Formatted Display type 2 and or a SMTTFD type 2 and or a type 2. A SMTTFD type 2 is a live, real time, A through Z, Alphabetical Order rotation cycle. A SMTTFD type 2 has the capacity of and or for Six Hundred Exchange listed stock symbols along with the depicted symbol's per share price and the daily change in price per One share of any given stock. Note, during Market Hours and or from a.m. 9:30 est. through p.m. 4:00 est. time, Monday through Fridays, except Federal Holidays any and or all of the depicted economic data is and or will be updated Once every Fifteen Minutes and or Once per rotation cycle and or Twenty Six times during “normal” Market Hours, live and or real time.

A Stock Market Ticker Tape Formatted Display type 2 and or a SMTTFD type 2 and or a type 2 has Four Fields of economic data depicted and or embedded within a String Format and or as a String of characters processed as a unit. The First of Four and or Field One of Four is a Character Field that depicts any and or all of the Exchange listed acronyms and or stock symbols. These said mentioned company acronyms and or stock symbols are comprised of and or made up of from as few as One to as many as Six characters and or letters. Each company listed with the depicted stock exchange is assigned a character specific acronym and or stock symbol. These stock symbols will be listed here in Field One of Four and or the Character Field.

The Second of Four and or Field Two of Four is a Number Field that depicts the live and or real time present value and or price of One share of the listed and or depicted symbol and or company presently being represented within this String of characters. Field Two of Four and or the First of Two Number Fields consist of Seven character spaces and or Four numbers, then a decimal point, then Two more numbers.

The Third of Four fields and or Field Three of Four is a Logic Field represented by a symbol that indicates the provision of Two choices. The First of Two choices offered within field Three of Four is an upright positioned pyramid shaped symbol. When this pyramid shaped symbol appears and or is depicted within an upright position this is an indication to the “user” of the machine that all of the economic data pertaining to this particular stock symbol and or all of the data embedded within the entire String of characters have gained and or are up in overall monetary value and or the per share price since such time as a.m. 9:30 est. time Opening Bell of the present day's ongoing, live Market Session. When this upright positioned pyramid shaped symbol appears and or is depicted all of the economic data embedded within the entire String of characters will be shown, displayed and or depicted in the color of Green.

The Second of Two choices offered within Field Three of Four and or the Logic Field is an inverted and or an upside down positioned pyramid shaped symbol. When this pyramid shaped symbol appears and or is depicted in an upside down position this is an indication to the “user” of the machine that all of the economic data pertaining to this particular stock symbol and or all of the data embedded within the entire String of characters is presently down in overall monetary value since such time as the beginning of this day and or since the a.m. 9:30 est,. time Opening Bell of this present day and or ongoing, live Market Session. When this inverted and or upside down positioned pyramid shaped symbol appears and or is depicted all of the economic data embedded within the entire String of characters will be shown, displayed and or depicted in the color of Red.

The Fourth of Four fields and or Field Four of Four is a Number Field and or the Second of Two Number Fields. Field Four of Four depicts the monetary value equivalent to the daily gain and or loss realized and or suffered by the depicted company and or the depicted stock symbol's per share price since such time as the beginning of this day and or since the a.m. 9:30 est. time Opening Bell of this present day and or this ongoing, live Market Session.

These Four fields and or Fields One through Four are formatted and depicted embedded within a String of characters that scroll from the Right side of the machine's viewing screen to the Left side of the screen. These Four said mentioned fields and or this entire String of characters will be shown, depicted and or displayed at a rate and or speed equivalent to Eight Hundred Eighty character fonts per Minute and or Twenty Two character fonts per One point Five Seconds of viewing and or display time. The exchange listed stock symbols are sequenced and or depicted embedded within an A through Z, Alphabetical order rotation cycle. All Number and Logic Fields depict the present day, live and or in real time prices. A SMTTFD type 2 can accomodate up to as many as Six Hundred Exchange Listed Stock Symbols.

A SMTTFD type 2 will be shown and or depicted embedded with scalable fonts with each character occupying the same and or an equal space. Each Field will be seperated One from the other by the width of One scalable font. These scalable font size spaces will remain and or be depicted blank. The blank spaces and or spacer fonts will be utilized for visual seperation and or as a perception aid.

This is the description of a Stock Market Ticker Tape Formatted Display type 3 and or a SMTTFD type 3 and or a type 3. A Stock Market Ticker Tape Formatted Display type 3 is an inactive and or dormant after Market Hours, A through Z, Alphabetical Order, color-coded'stock market ticker tape formatted display. A SMTTFD type 3 has a capacity of and or for Six Hundred stock symbols, these stock symbols rotate and or scroll within a Fifteen Minute roataion cycle.

During the after Market Hours sessions and or at p.m. 4:00 est. time the Closing Bell prices are posted. These posted symbols along with their per share price and the stock's daily gain and or loss will be reiterated Once every Fifteen Minutes until such time as the a.m. 9:30 est. time Opening Bell of the next, live Market session.

A Stock Market Ticker Tape Formatted Display type 3 and or a SMTTFD type 3 and or a type 3 has Four fields of economic data depicted and or embedded within a String Format and or formation and or as a series of characters processed as a unit. The First of Four and or Field One of Four is a Character Field that depicts exchange listed stock symbols. These company acronyms and or stock symbols are comprised of and or made up of from as few as One to as many as Six characters and or letters. Each company listed with the depicted stock exchange is assigned a character specific acronym and or stock symbol. These stock symbols will be listed here in Field One of Four and or the Character Field.

The Second of Four and or Field Two of Four is a Number Field that depicts the present day p.m. 4:00 est. time Closing Bell value and or per share price of the depicted and or adjoining stock symbol.

The Third of Four fields and or Field Three of Four is a Logic Field represented by a symbol that indicates the provision of Two choices. The First of Two choices offered within Field Three of Four is an upright positioned pyramid shaped symbol. When this pyramid'shaped symbol appears and or is depicted within an upright position this is an indication to the “user” of the machine that all of the economic data pertaining to this particular stock symbol and or all of the data embedded within this entire String of characters closed higher and or gained in overall monetary value during the last and or at the end of the last, live Market session. When this upright positioned pyramid shaped symbol appears and or is depicted all of the economic data embedded within the entire String of characters will be shown, displayed and or depicted in the color of Green.

The Second of Two choices offered within Field Three of Four is an inverted and or an upside down positioned pyramid shaped symbol. When this pyramid shaped symbol appears and or is depicted within an inverted and or in an upside down position this is an indication to the “user” of the machine that all of the economic data pertaining to this particular stock symbol and or all of the data embedded within the entire String of characters closed lower in monetary value and or posted a loss at the end of the last, live Market session. When this inverted and or upside down positioned pyramid shaped symbol appears and or is depicted all of the economic data embedded within the entire String of characters will be shown, displayed and or depicted in the color of Red.

The Fourth of Four fields and or Field Four of Four is a Number Field and or the Second of Two Number Fields. Field Four of Four depicts the monetary value equivalent to the daily gain and or loss realized and or suffered since the beginning of the last Trading Session and or from the last sounding of Opening Bell to and through Closing Bell and or p.m. 4:00 est. time of the last, live Market Session.

These Four fields and or Fields One through Four are formatted and or depicted embedded within a String of characters that scroll from the Right side of the machine's viewing screen to the Left side of the screen. These Four said mentioned fields and or this entire String of characters will be shown, displayed and or depicted at a rate and or speed equivalent to Eight Hundred Eighty character fonts per Minute and or Twenty Two character fonts per One point Five Seconds. The Exchange listed stock symbols are sequenced and or depicted embedded within an A through Z, Alphabetical Order rotation cycle. All Number and Logic Fields depict the p.m. 4:00 est. time Closing Bell prices posted at the end of the last, live Market Session. A type 3 can accomodate up to as many as Six Hundred Exchange listed stock symbols.

A SMTTFD type 3 will be shown, displayed and or depicted embedded with scalable fonts with each character occupying the same and or an equal space. Each field will be seperated One from the other by the width of One scalable font. This scalable font size space will remain and or be depicted empty and or blank. This blank space and or spacer font will be utilized for visual seperation and or as a perception aid.

This is a description of a Stock Market Ticker Tape Formatted Display type 4 and or a SMTTFD type 4 and or a type 4. A SMTTFD type 4 is a live and or real time, Customized, Personal Portfolio, Stock Market Ticker Tape consisting of an array of stock symbols extracted from and or listed with from as few as One to as many as Three U.S. Stock Exchanges, the NYSE, the NASDAQ and the AMEX along with the “user” of the machine's portfolio's monetary value and Money Market Fund balance depicted within Five predetermined and or sequenced positions.

The First Three of Five said mentioned positions and or position One, Two and Three contain Five fields of data per position. The Fourth of Five positions and or position Four contains Four fields of data. The Fifth of Five positions and or position Five contains Two fields of data.

Position One of Five, Field One of Five is a Character Field that depicts the acronym and or the symbol that represents the stock exchange from which the following and or the proceeding stock symbols have been extracted from. This position and or position One of Five, Field One of Five is reserved for the NYSE and or the New York Stock Exchange, therefore position One of Five is a Character Field that depicts Four characters and or letters symbolizing the listed exchange in acronym form and or as the NYSE.

Position One of Five, Field Two of Five is a Character Field that depicts the NYSE and or the New York Stock Exchange's listed company's acronyms and or listed company's stock symbols. These NYSE listed acronyms and or NYSE listed stock symbols ill be comprised of and or made up of from as few as One to as many as Six characters and or letters.

Position One of Five, Field Three of Five is a Number Field that depicts the a.m. 9:30 est. time through the p.m. 4:00 est. time, continuously updated, live monetary value and or price of One share of the depicted company's stock.

Position One of Five, Field Four of Five is a Logic Field represented by a symbol that indicates the provision of Two choices. The First of Two choices offered within position One of Five, Field Four of Five and or choice One is an upright positioned pyramid shaped symbol. When this'said mentioned pyramid shaped symbol appears and or is depicted within an upright position this is an indication to the “user” of the machine that all of the economic data pertaining to this particular stock symbol and or all of the data embedded within this String of characters are presently higher and or have gained in monetary value since such time as the opening of the market on this given day and or since the a.m. 9:30 est. time Opening Bell of this present ongoing, live Market Session. When this upright positioned:pyramid shaped symbol appears and or is depicted all of the economic data embedded within the entire String of characters will be shown, displayed and or depicted in the color of Green.

The Second of Two choices offered within position One of Five, Field Four of Five and or choice Two is an inverted and or an upside down positioned pyramid shaped symbol. When this pyramid shaped symbol appears and or is depicted this is an indication to the “user” of the machine that all of the economic data pertaining to this particular company and or depicted stock symbol and or all of the data within this String of characters are presently lower and or have lost value since such time as the opening of the Markets on this given day and or since the Opening Bell of this present day, ongoing live Market session. When this inverted and or upside down positioned pyramid shaped symbol appears and or is depicted all of the economic data embedded within the entire String of characters will be shown, displayed and or depicted in the color of Red.

Position One of Five, Field Five of Five is a Number Field that depicts the monetary value equivalent to the daily gain and or loss realized and or suffered by the depicted company and or the depicted stock symbol's per share price since such time as the beginning of the present ongoing, live Market session and or since the a.m. 9:30 est. time Opening Bell.

Position One of Five, Fields One through Five are shown, displayed and or depicted embedded within a String of characters that scroll from the Right side of the machine's viewing screen to the Left side of the screen. These Five said mentioned fields and or this String of characters will be depicted at a rate and or speed equivalent to Eight Hundred Eighty character fonts per Minute and or Twenty Two character fonts per One point Five Seconds.

The NYSE and or the New York Stock Exchange's listed stock symbols are sequenced and or depicted witin an A through Z, Alphabetical Order rotation cycle. All Number and Logic Fields are updated at the end of position Five of Five, Field Two of Two and or just prior to the beginning of position One of Five, Field One of Five.

Position One of Five can accomodate from as few as none and or One to as many as Six Hundred NYSE listed Stock symbols. The depicted Strings of characters will be shown, displayed and or depicted with scalable fonts with each character occupying the same and or equal space. Each field will be seperated One from the other by the equivalent of the width of One scalable font. This scalable font space will remain and or be depicted empty and or utilized for visual seperation and or as a perception aid.

Position Two of Five, Field One of Five is reserved for the NASDAQ Stock Exchange's acronym, therefore Field One of Five is a Character Field that depicts Five characters and or letters and or the acronym NASDAQ.

Position Two of Five, Field Two of Five is a Character Field that depicts the NASDAQ Stock Exchange's listed company acronyms and or the NASDAQ Stock Exchange's listed stock symbols. These NASDAQ listed stock symbols are comprised of and or made up of from as few as One to as many as Six characters and or letters.

Position Two of Five, Field Three of Five is a Number Field that depicts the current and or live and or real time price and or the monetary value of One share of the depicted company's stock.

Position Two of Five, Field Four of Five is a Logic Field represented by a pyramid shaped symbol that indicates the provision of Two choices. The First of Two choices offered within position Two, Field Four of Five and or choice One is an upright positioned pyramid shaped symbol. When this said mentioned pyramid shaped symbol appears and or is depicted in an upright position this is an indication to the “user” of the machine that all of the economic data pertaining to this particular stock symbol and or all of the data embedded within this String of characters are presently higher and or have gained in monetary value since such time as the opening of the Market on this given day and or since the a.m. 9:30 est. time Opening Bell of the present,.ongoing live Market session. When this upright positioned pyramid shaped symbol appears and or is depicted all of the economic data embedded within the entire String of characters will be depicted in the color of Green.

The Second of Two choices offered within Position Two, Field Four of Five and or choice Two is an inverted and or an upside down positioned pyramid shaped symbol. When this pyramid shaped symbol appears and or is depicted in an inverted and or in an upside down position this is an indication to the “user” of the machine that all of the economic data pertaining to this particular stock symbol and or all of the data embedded within this String of characters are presently lower and or have lost value since the opening of the Market on this given day and or since the a.m. 9:30 est. time Opening Bell of the present, ongoing live Market session. When this inverted and or upside down positioned pyramid shaped symbol appears and or is depicted all of the economic data embedded within the entire String of characters will be depicted in the color of Red.

Position Two of Five, Field Five of Five is a Number Field that depicts the change in monetary value equivalent to the daily gain and or loss realized and or suffered by the depicted company and or the depicted stock symbol's per share price since such time as the beginning of this day and or since the Opening Bell of the present, ongoing live Market session.

Position Two of Five, Fields One through Five are depicted within a String of characters that scroll from the Right side of the machine's viewing screen to the Left side of the screen. These Five said mentioned fields and or this String of characters will be shown, displayed and or depicted at a rate and or speed equivalent to Eight Hundred Eighty character fonts per Minute and or Twenty Two character fonts per One point Five Seconds of display and or viewing time.

These said mentioned NASDAQ Exchange listed stock symbols are sequenced and or are depicted within an A through Z. Alphabetical Order rotation cycle. All Number and Logic Fields are updated with new, real time, live data at the end of Position Five, Field Two of Two and or just prior to the beginning of Position One of Five, Field One of Five.

Position Two of Five can accomodate from as few as none and or One to as many as and or up to Six Hundred NASDAQ listed stock symbols. When occupyed by a symbol each of the Six Hundred symbol positions are depicted for One point Five Seconds of display and or viewing time per cycle.

The String of characters will be depicted with scalable fonts with each character, letter, number and or symbol occupying the same and or equal space. Each field will be seperated One from the other by the equivalent of the width of One scalable font. These character font size spaces will remain empty and or utilized for visual seperation and or as a perception aid.

Position Three of Five, Field One of Five is reserved for the AMEX and or the American Stock Exchange, therefore Field One of Five is a Character Field that depicts Four characters and or letters symbolizing the listed exchange in acronym form and or as the AMEX.

Position Three of Five, Field Two of Five is a Character Field that depicts the AMEX Stock Exchange's listed company's acronyms and or AMEX listed stock symbols. The AMEX stock exchange listed stock symbols are comprised of and or made up of from One to Six characters and or letters.

Position Three of Five, Field Three of Five is a Number Field that depicts the current and or live and or real time prices and or values indicative to the asking price for One share of the depicted company's stock.

Position Three of Five, Field Four of Five is a Logic Field represented by a symbol that indicates the provision of Two choices.

The First of Two choices offered within position Three of Five, Field Four of Five and or choice One is an upright positioned pyramid shaped symbol. When this said mentioned pyramid shaped symbol appears and or is depicted in an upright position this is an indication to the “user” of the machine that all of the economic data pertaining to this particular stock symbol and or all of the data embedded within this String of characters is presently Trading higher and or has gained in overall value since such time as the opening of the Markets on this given day and or since the a.m. 9:30 est. time Opening Bell of the present, ongoing live Market session. When this upright positioned pyramid shaped symbol appears and or is depicted any and or all of the economic data formatted and or embedded within the entire String of characters will be depicted in the color of Green.

The Second of Two choices offered within position Three of Five, Field Four of Five and or choice Two is an inverted and or an upside down positioned pyramid shaped symbol. When this pyramid shaped symbol appears and or is depicted in an inverted and or in an upside down position this is an indication to the “user” of the machine that any and or all of the economic data pertaining to this particular stock symbol and or all of the data embedded within this String of characters is presently Trading lower and or has lost value since the opening of the Markets on this given day and or since the a.m. 9:30 est. time Opening Bell of this present, ongoing live Market session. When this inverted and or upside down positioned pyramid shaped symbol appears and or is depicted any and or all of the economic data formatted and or embedded within the entire String of characters will be depicted in the color of Red.

Position Three of Five, Field Five of Five is a Number Field that depicts the change in monetary value equivalent to the daily gain and or loss realized and or suffered by the depicted company and or the depicted stock symbol's per share price since the beginning of this given day and or the beginning of the trading session and or since the a.m. 9:30 est. time Opening Bell of the present, ongoing live Market session.

Position Three of Five, Fields One through Five are depicted within a String of characters that scroll from the Right side of the machine's viewing screen to the Left side of the screen. These Five said mentioned fields and or this String of characters will be displayed and or depicted for One point Five Seconds of viewing time, Once per rotation cycle.

The AMEX and or the American Stock Exchange listed stock symbols are sequenced, displayed and or depicted embedded within an A through Z, Alphabetical Order rotation cycle. All Number and Logic Fields are updated with new economic data at the end of Position Five of Five, Field Two of Two and or just prior to Position One of Five, Field One of Five.

Position Three of Five can accomodate from as few as none and or One to as many as Six Hundred AMEX listed stock symbols. Presently the AMEX list approximately Five Hundred Seventy Six company stock symbols, therefore Position Three of Five can accomodate any and or all of the American Stock Exchange's listing of company's stock symbols. Each AMEX listed stock symbol along with any and or all adjoining economic data will be depicted and or will scroll at the rate and or speed equivalent to Eight Hundred Eighty character fonts per Minute and or Twenty Two character fonts per One point Five Seconds

The String of characters will be depicted and or illustrated embedded with scalable fonts with each character, letter, number and or symbol occupying the same and or an equal space. Each field will be seperated One from the other by the equivalent width of One scalable font. These character font size spaces will remain and or be depicted empty and or utilized for visual seperation and or as a perception aid.

Position Four of Five, Field One of Four is a Character Field that depicts the words PORTFOLIO VALUE and or Nine character fonts, then the width of One scalable font left empty and or utilized as a spacer, then Five character fonts and then another spacer.

Position Four of Five, Field Two of Four is a Number Field representative of the “user” of the machine's personal portfolio value. Any and or all machine purchased stocks and or stock symbols will be depicted embedded within this Customized, Personal Portfolio, Stock Market Ticker Tape scrolling along on the machine's viewing screen. Position Four of Five, Field Two of Four and or the Number Field represented their of is a calculation indicative of the monetary value of any and or all of the stock shares depicted and or scrolling on the machine's viewing screen embedded within this “user” of the machine's Customized, Personal Portfolio, Stock Market Ticker Tape. Therefore and or in retrospect Position Four of Five, Field Two of Four is a Number Field that depicts the monetary value of the “user” of the machine's personal portfolio account.

Position Four of Five, Field Three of Four is a Logic Field represented by a symbol that indicates the provision of Two choices. The First of Two choices offered within Position Four of Five, Field Three of Four is an upright positioned pyramid shaped symbol. When this upright positioned pyramid shaped symbol appears and or is depicted this is an indication to the “user” of the machine that all of the economic data formatted and or embedded within the entire String of characters is presently Trading higher and or has gained in overall monetary value since such time as the opening of the Markets on this given day and or since the a.m. 9:30 est. time Opening Bell of the present, ongoing live Market session. When this pyramid shaped symbol appears and or is depicted in an upright position all of the economic data formatted and or embedded within the entire String of characters will be depicted in the color of Green.

The Second of Two choices offered within Position Four of Five, Field Three of Four and or choice Two is an inverted and or an upside down positioned pyramid shaped symbol. When this said mentioned pyramid shaped symbol appears and or is depicted inverted and or is presented as an upside down positioned pyramid shaped symbol this is an indication to the “user” of the machine that any and or all of the economic data embedded within this entire String of characters is presently Trading lower and or has lost value and or the overall monetary value of the “user” of the machine's personal portfolio account is lower since such time as the opening of the Markets on this given day and or since such time as the a.m. 9:30 est. time Opening Bell of the present, ongoing live Market session. When this inverted and or upside down positioned pyramid shaped symbol appears and or is depicted any and or all of the economic data pertaining to and or all of the numbers, letters and symbols formatted and or embedded within the entire String of characters will be depicted and or illustrated in the color of Red.

Position Four of Five, Field Four of Four is a Number Field that depicts the monetary value equivalent to the daily gain and or loss realized and or suffered by the combined companies and or the combined total of the stock share prices since such time as the beginning of this given day and or since the a.m. 9:30 est. time Opening Bell of this present, ongoing live Market session.

Position Four of Five, Fields One through Four are depicted within a String of characters that scroll from the Right side of the machine's viewing screen to the Left side of the screen. These Four said mentioned fields and or this String of characters will be displayed on the machine's viewing screen for One point Five Seconds per viewing and or per rotation cycle. All Number and Logic Fields are updated with new economic data at the end of Position Five of Five, Field Two of Two and or just prior to Position One of Five, Field One of Five.

The entire String of characters will be depicted embedded with scalable fonts with each font and or characater occupying the same and or an equal space. Each field will be seperated One from the other by and or equivalent to the width of One scalable font. These font size spacers will remain empty and or be depicted blank and or utilized for visual seperation and or as a perception aid.

The rotation cycle rate and or speed is Eight Hundred Eighty character fonts per Minute and or Twenty Two character fonts per One point Five Seconds.

Position Five of Five, Field One of Two is a Character Field that depicts the words MONEY MARKET and or Five characters, then One spacer and or blank font space, then Six characters followed by another blank font space. These Two words and or MONEY MARKET, indicate to the “user” of the machine that the adjoining monetary value is representative of the available funds and or the balance of funds within the “user” of the machine's adjoining Money Market Fund account and or adjoining bank account.

Position Five of Five, Field Two of Two is a Number Field that depicts the ammount of cash and or money that is still available within the “user” of the machine's account.

The String of characters will be depicted and or illustrated with Black colored scalable fonts with each character occupying an equal space. Each of the Two fields will be seperated One from the other by a width equivalent to One scalable font. This font space will remain empty and or be depicted blank and or utilized for visual seperation and or as a perception aid. These said mentioned character fonts will scroll at a rate and or speed of Eight Hundred Eighty characters per Minute and or Twenty Two characters per One point Five Seconds of viewing and or display time per rotation cycle.

In retrospect, as said mentioned throughout this “user” of the machine's portfolio stock market ticker tape type 4 explanatory and or this Customized, Personal Portfolio, Stock Market Ticker Tape type 4 descriptive and or this SMTTFD type 4 and or this type 4, this is the place and or this is the time when any and or all of the economic data is updated and or calculated and or reconfigured to represent the present, live, real time values and or prices embedded within this SMTTFD type 4.

This is a discription of a Stock Market Ticker Tape Formatted Display type 5 and or a SMTTFD type 5 and or a type 5. A SMTTFD type 5 is a dormant, after Market Hours, p.m. 4:00 est. time Closing Bell prices reiterated, Customized, Personal Portfolio, Stock Market Ticker Tape Formatted Display consisting of an array of stock symbols extracted from and or listed with from as few as One to as many as Three U.S. Stock Exchanges, the NYSE, the NASDAQ and the AMEX along with the “user” of the machine's personal portfolio/Money Market accounts monetary values depicted embedded within Five predetermined and or sequenced positions.

The First Three of Five said mentioned positions and or Position One, Two and Three contain Five fields of data per position. The Fourth of Five positions and or Position Four contains Four fields of data. The Fifth of Five positions and or Position Five contains Two fields of data.

Position One of Five, Field One of Five is a Character Field that depicts the acronym and or the symbol that represents the Stock Exchange from which the following content and or stock symbols have been extracted from. This position and or Position One of Five, Field One of Five is reserved for the NYSE and or the New York Stock Exchange, therefore Position One of Five, Field One of Five is a Character Field depicting Four characters and or letters symbolizing the listed exchange in acronym form and or as the NYSE.

Position One of Five, Field Two of Five is a Character Field that depicts the NYSE and or the New York Stock Excbange's listed company acronyms and or listed company's stock symbols. These NYSE listed acronyms and or these NYSE listed stock symbols will be comprised of and or made up of from as few as One to as many as Six characters and or letters.

Position One of Five, Field Three of Five is a Number Field that depicts the p.m. 4:00 est. time Closing Bell price and or monetary value of One share of the depicted company's stock.

Position One of Five, Field Four of Five is a Logic Field represented by a symbol that indicates the provision of Two choices. The First of Two choices offered within Position One of Five, Field Four of Five is an upright positioned pyramid shaped symbol. When this said mentioned pyramid shaped symbol appears and or is depicted within an upright position this is an indication to the “user” of the machine that all of the economic data pertaining to this particular stock symbol and or all of the data embedded within this String of characters “Closed” and or ended the last Market session higher and or gained in overall value since the opening of the Markets on this given day and or since the Opening Bell until such time as the last recorded value and or the p.m. 4:00 est. time Closing Bell prices posted at the end of the last, ongoing live Market session. When this upright positioned pyramid shaped symbol appears and or is depicted all of the economic data embedded within the entire String of characters will be shown and or depicted in the color of Green.

The Second of Two choices offered within Position One of Five, Field Four of Five and or choice Two is an inverted and or an upside down positioned pyramid shaped symbol. When this pyramid shaped symbol appears and or is depicted in an inverted and or in an upside down position this is an indication to the “user” of the machine that all of the economic data pertaining to this particular company and or this depicted symbol and or all of the data embedded within this String of characters, closed and or ended the last live Market session lower and or lost in overall value since the opening of the Markets on this given day and or since the Opening Bell until such time as the last recorded and or posted monetary values were last posted at the depicted exchange. When this inverted and or upside down positioned pyramid shaped symbol appears and or is depicted all of the economic data embedded within the entire String of characters will be shown and or depicted in the color of Red.

Position One of Five, Field Five of Five is a Number Field that depicts the monetary value equivalent to the daily gain and or loss realized and or suffered by the depicted company and or the depicted stock symbol's per share price since the beginning of the Trading Session and or since Opening Bell of the last, ongoing live Market Session.

Position One of Five, Fields One through Five are shown, displayed and or depicted embedded within a String of characters that scroll from the Right side of the machine's viewing screen to the Left side of the screen. These Five said mentioned fields and or this String of characters will be depicted at a rate and or speed equivalent to Eight Hundred Eighty character fonts per Minute and or Twenty Two character fonts per One point Five Seconds.

The NYSE and or the New York Stock Exchange's listed stock symbols are sequenced and or depicted embedded within an A through Z, Alphabetical Order rotation cycle. All Number and Logic Fields depict the p.m. 4:00 est. time Closing Bell prices and or monetary values posted last and or at the end of the last, ongoing live Market Session. The Closing Bell prices will be reiterated throughout the after Market Hours Session and or until such time as when the Stock Markets open for the business of Trading shares of listed company's stock and or until the a.m. 9:30 est. time Opening Bell of the next live Market Session.

Position One of Five can accomodate from as few as none and or One to as many as Six Hundred NYSE and or New York Stock Exchange listed stock symbols. Each of the depicted Strings of characters will be shown and or displayed embedded with scalable fonts with each character occupying the same and, or equal space. Each field will be seperated One from the other by a width equivalent to One scalable font. This font size space will remain and or be depicted empty and or utilized for visual seperation and or as a perception aid.

Position Two of Five, Field One of Five is reserved for the NASDAQ Stock Exchange's acronym, therefore Field One of Five is a Character Field that depicts Five characters and or letters representing and or symbolizing the listed exchange in acronym form and or as the NASDAQ.

Position Two of Five, Field Two of Five is a Character Field that depicts the NASDAQ Stock Exchange's listed company's acronyms and or the NASDAQ's listed stock symbols. These NASDAQ exchange listed stock symbols are comprised of and or made up of from as few as One to as many as Six characters and or letters.

Position Two of Five, Field Three of Five is a Number Field that depicts the p.m. 4:00 est. time Closing Bell values and or prices that were posted at the end and or close of the last, ongoing live Market Session representing and or equivalent to the monetary value and or price for One share of the depicted company's stock.

Position Two of Five, Field Four of Five is a Logic Field represented by a pyramid shaped symbol that indicates the provision of Two choices. The First of Two choices offered within Position Two of Five, Field Four of Five and or choice One is an upright positioned pyramid shaped symbol. When this said mentioned pyramid shaped symbol appears and or is depicted, in an upright position this is an indication to the “user” of the machine that all of the economic data pertaining to this particular stock symbol and or all of the data embedded within this String of characters Traded and or posted higher at the p.m. 4:00 est. time Closing Bell price and or closed realizing a gain in overall. monetary value since such time as the a.m. 9:30 est. time Opening Bell prices were last posted. When this upright positioned pyramid shaped symbol appears and or is depicted all of the economic data embedded within the entire String of characters will be depicted in the color of Green.

The Second of Two choices offered within Position Two of Five, Field Four of Five and or choice Two is an inverted and or an upside down positioned pyramid shaped symbol. When this pyramid shaped symbol appears and or is depicted in an inverted and or in an upside position this is an indication to the “user” of the machine that all of the economic data embedded within this String of characters closed and or ended the last live Market Session Trading lower and or posted a loss in overall monetary value since such time as when the Markets opened on this given day and or since the Opening Bell until such time as the last recorded and or posted value and or at p.m. 4:00 est. time of the last, ongoing live Market Session. When this inverted and or upside down positioned pyramid shaped symbol appears and or is depicted all of the economic data embedded within the entire String of characters will be depicted in the color of Red.

Position Two of Five, Field Five of Five is a Number Field that depicts the change in monetary value equivalent to the daily gain and or loss realized and or suffered by the depicted company and or the depicted stock symbol's per share price posted at the Closing Bell and or at p.m. 4:00 est. time of the last, ongoing live Market Session.

Position Two of Five, Fields One through Five are depicted embedded within a String of characters that scroll from the Right side of the machine's viewing screen to the Left side of the screen. These Five said mentioned fields and or this String of characters will be shown, displayed and or depicted at a rate and or speed equivalent to Eight Hundred Eighty character fonts per Minute and or Twenty Two character fonts per One point Five Seconds of display and or viewing time.

These said mentioned NASDAQ Stock Exchange listed symbols are sequenced and or depicted embedded within an A through Z, Alphabetical Order rotation cycle. All Number and Logic Fields depict the reiterated Closing Bell prices and or the p.m. 4:00 est. time posted values concerning the last, ongoing live Market Session until such time as when the Markets open for the business of Trading Shares of listed company's stock once again.

Position Two of Five can accomodate from as few as none and or One to as many as and or up to Six Hundred NASDAQ Exchange listed stock symbols. When utilized, each of the Six Hundred symbol positions are depicted for One point Five seconds per rotation cycle.

The String of characters will be depicted with scalable fonts with each character, symbol, letter and or number occupying the same and or equal space. Each field will be seperated One from the other by a width equivalent to One scalable font. These font size spaces will remain empty and or utilized for visual seperation and or as a perception aid.

Position Three of Five, Field One of Five is reserved for the AMEX and or the American Stock Exchange, therefore Field One of Five is a Character Field that depicts Four characters and or letters symbolizing the listed exchange in acronym form and or as the AMEX.

Position Three of Five, Field Two of Five is a Character Field that depicts the AMEX Stock Exchange's listed acronyms and or the American Stock Exchange's listed stock symbols. The AMEX exchange listed stock symbols will be comprised of and or made up of from as few as One to as many as Six characters and or letters.

Position Three of Five, Field Three of Five is a Number Field that depicts the Closing Bell prices and or the p.m. 4:00 est. time value posted at the end of the last, ongoing, live Market Session equivalent to the monetary value and or the price of One share of the depicted company's stock.

Position Three of Five, Field Four of Five is a Logic Field represented by a symbol that indicates the provision of Two choices. The First of Two choices offered within Position Three of Five, Field Four of Five is an upright positioned pyramid shaped symbol. When this said mentioned pyramid shaped symbol appears and or is depicted in an upright position this is an indication to the “user” of the machine that all of the economic data pertaining to this particular stock symbol and or all of the data formatted and or embedded within this String of characters closed and or posted higher and or posted as gaining in :overall value during the last, ongoing live Market session. When this upright positioned pyramid shaped symbol appears and or is depicted any and or all of the economic data formatted and or embedded within the entire String of characters will be depicted in the color of Green.

The Second of Two choices offered within Position Three of Five, Field Four of Five and or choice Two is an inverted and or an upside down positioned pyramid shaped symbol. When this pyramid shaped symbol appears and or is depicted in an inverted and or in an upside down position this is an indication to the “user” of the machine that any and or all of the economic data pertaining to and or depicted with this particular stock symbol and or all of the data formatted and or embedded within this String of characters closed Trading lower and or has suffered a loss in overall monetary value between the hours of Opening Bell a.m. 9:30 est. time through the Closing Bell p.m. 4:00,est. time and or the Closing Bell prices and or values, posted at the end of the last ongoing, live Market session. When this inverted and or upside down positioned pyramid shaped symbol appears and or is depicted any and or all of the economic data formatted and or embedded within the entire String of characters will be depicted in the color of Red.

Position Three of Five, Field Five of Five is a Number Field that depicts the change in monetary value equivalent to the daily gain and or loss realized and or suffered by the depicted company and or the depicted stock symbol's per share price posted at the end of the last ongoing, live Market Session.

Position Three of Five, Fields One through Five are depicted embedded within a String of characters that scroll from the Right side of the machine's viewing screen to the Left side of the screen. These Five said mentioned fields and or this String of characters will be shown, displayed and or depicted at a rate and or speed equivalent to Eight Hundred Eighty character fonts per Minute and or Twenty Two character fonts per One point Five Seconds of viewing and or display time.

The AMEX Stock Exchange listed stock symbols are sequenced and or depicted embedded within an A through Z, Alphabetical Order rotation cycle. All Number and Logic Fields depict the reiterated Closing Bell prices and or the p.m. 4:00 est. time posted values concerning the last ongoing, live Market session until such time as when the Markets open for the business of Trading shares of listed company's stock once again.

Position Two of Five can accomodate from as few as none and or One to as many as and or up to Six Hundred stock symbols (presently the amex list approximately 576 symbols), therefore, any and or all of the AMEX listed stock symbols can be accomodated for within Position Three of Five of this SMTTFD type 5.

The String of characters will be formatted and or embedded with scalable fonts with each of the characters and or letters, numbers and symbols occupying the same and or equivalent space. Each Field will be seperated One from the other by a width equivalent to One scalable font. These font size spaces will remain empty and or utilized for visual seperation and or as a perception aid.

Position Four of Five, Field One of Four is a Character Field that depicts the words PORTFOLIO VALUE and or Nine character fonts, followed by the space equivalent to One scalable font, then Five more character fonts, then another spacer and or space equivalent to One scalable font.

Position Four of Five, Field Two of Four is a Number Field representative of the “user” of the machine's portfolio value. Any and or all stock shares purchased by the “user” of the machine by ways and or means of the machine will be depicted and or displayed embedded within the “user” of the machine's Customized, Personal Portfolio, Stock Market Ticker Tape and or the SMTTFD type 5 and or the type 5 scrolling on the machine's viewing screen. Position Four of five, Field Two of Four is a Number Field representative their of is a calculation indicative of the monetary value of any and or all of the stock shares depicted and or embedded within this SMTTFD type 5 scrolling on the machine's viewing screen. Therefore and or in retrospect Position Four of Five, Field Two of Four is a Number Field that depicts the overall monetary value of the “user” of the machine's personal portfolio account.

Position Four of Five, Field Three of Four is a Logic Field represented by a symbol that indicates the provision of Two choices. The First of Two choices offered within Position. Four of Five, Field Three of Four is an upright positioned pyramid shaped symbol. When this pyramid shaped symbol appears and or is depicted in an upright position this is an indication to the “user” of the machine that all of the economic data depicted embedded within this String of characters closed Trading higher and or posting a gain as of the last ongoing, live Market session. When this said mentioned pyramid shaped symbol appears and or is depicted all of the economic data embedded within the entire String of characters will be depicted in the color of Green.

The Second of Two choices offered within Position Four of Five, Field Three of Four and or choice Two is an inverted and or an upside down positioned pyramid shaped symbol. When this said mentioned pyramid shaped symbol is depicted inverted this is an indication to the “user” of the machine that all of the economic data embedded within this String of characters closed trading lower and or posted a loss as of the p.m. 4:00 est. time Closing Bell prices posted at the end of the last ongoing, live Market session. When this inverted and or upside down positioned pyramid shaped symbol appears and or is depicted any and or all of the economic data pertaining to and or all of the letters, numbers and symbols embedded within the entire String of characters will be depicted in the color of Red.

Position Four of Five, Field Four of Four is a Number Field that depicts the monetary value equivalent to the daily gain and or loss realized and or suffered by the combined companies and or the combined total of the stock share prices posted at the end of the last live Market session.

Position Four of Five, Fields One through Four are depicted embedded within a String of characters that scroll from the Right side of the machine's viewing screen to the Left side of the screen. These Four said mentioned fields and or this String of characters will be scrolling and or depicted for approximately One point Five Seconds per viewing. All Number and Logic Field values and or prices will be reiterated throughout the after Market Hours session and or until such time as the a.m. 9:30 est. time Opening Bell prices are posted marking the beginning of the next live Market session.

The String of characters will be depicted embedded with scalable fonts with each character and or letters, numbers and symbols occupying the same and or an equivalent space. Each field will be seperated One from the other by a width equivalent to One scalable font. These font size spacers and or spaces will remain empty and or utilized for visual seperation and or as a perception aid.

Position Five of Five, Field One of Two is a Character Field that depicts the words MONEY MARKET and or Five chartacters, One space then Six additional characters. These Two words MONEY MARKET is an indication to the “user” of the machine that the following adjoining economic data and or depicted monetary value represents the available funds and or the balance of funds available within the “user” of the machine's Money Market Fund Account.

Position Five of Five, Field Two of Two is a Number Field that depicts as said mentioned the ammount of cash and or money left and or that is still available within the “user” of the machine's Money Market Fund Account.

This String of characters will be depicted with Black colored scalable fonts with each character, letter, number and or symbol occupying an equal space. Each of these Two fields will be seperated One from the other by a width equivalent to One scalable font. This scalable font size space will be depicted empty and or blank, the spacing is utilized for visual seperation and or as a perception aid.

This is the place in the rotation cycle where any and or all of the economic data depicted embedded within this SMTTFD type 5 repeats and or is reiterated throughout the after Market Hours session until such time as a.m. 9:30 est. time Opening Bell of the next live, Market session.

This is a description of a Stock Market Ticker Tape Formatted Display type 6 and or a SMTTFD type 6 and or a type 6. A SMTTFD type 6 is a dormant, pre Market Hours a.m 9:15 est. time, A through Z, Alphabetical Order, stock market ticker tape. Type 6 is depicted for only One rotation cycle per after Market Hours session and or the last of the Fifteen Minute rotation cycles prior to the a.m. 9:30 est. time Opening Bell and or at precisely 9:15 est. time just prior to the start of the next live Market session.

A SMTTFD type 6 depicts a Blue colored background formatted and or embedded with White characters and or White letters, numbers and symbols. Type 6 does not depict the daily change in value of the depicted stock symbols as did the Five previously stated Stock market ticker tape formatted displays and or SMTTFD types One through Five. The plausible reasoning for this deletion in regard to the daily change in value is that the Machine 1 and or the machine is clearing and or deleting all of the previously retained Closing Bell prices and or values in preperation for the a.m. 9:30 est. time Opening Bell of the next live Market session.

A SMTTFD type 6 has Two fields of economic data depicted embedded within A String of characters format and or as a series of characters processed as a unit. The First of Two fields and or Field One of Two is a Character Field that depicts the exchange listed company acronyms and or the exchange listed stock symbols. These said mentioned acronyms and or stock symbols are comprised of and or made up of from as few as One to as many as Six characters and or letters. Each of the Exchange listed companies is assigned and or referred to by their own unique acronym and or stock symbol.

The Second of Two fields and or Field Two of Two is a Number Field that depicts the p.m. 4:00 est. time Closing Bell prices pertaining to the value and or price of One share of stock from the represented company acronym and or stock symbol posted at the end of the last live Market session.

Each rotation cycle is comprised of and or made up of Six Hundred exchange listed stock symbol positions. Each stock symbol along with any and or all pertinent economic data is depicted for One point Five Seconds per symbol. Six Hundred symbol positions times One point Five seconds per position equals Nine Hundred Seconds and or Fifteen Minutes per rotation cycle.

The String of characters will be formatted and or embedded with scalable fonts with each character and or symbol, letter and or number occupying the same and or equivalent space. Field One and Field Two will be seperated One from the other by a width equivalent to One scalable font. This scalable font size spacer and or space will remain empty and or utilized for visual seperation and or as a perception aid.

The Machine 1 Dissemination Center is a brick and mortar structure that houses the Mainframe Computer Servers and the telecommunications systems deemed necessary for the Machine 1 and or the machine's normal modes of operation. The Dissemination Center's Mainframe Computer Servers include but are not limited to Four types of servers.

The First of Four types of Mainframe Computer servers is a Database Server, this server processes database queries. The Second of Four types of servers is a File Server, this Mainframe Computer Server and or storage device is deticated to storing files. Any and or all “users” of the machine and or machines can and will be storing files within this server. The Third of Four types of Mainframe Computer Servers is a Print Server, this Print Server handles the One or more printers deemed necessary for normal modes of operation. The Fourth of Four types of Mainframe Computer Servers is a Network Server, this Server manages all of the Network traffic.

These Four types of Mainframe Computer Servers are directly linked via a T-3 Fiber Optic Network Multiplexor with BURST technolgies, directly to and through a contracted National, Digital Radio Network with access to the global network of Digital Radio Towers.

The Machine 1 Dissemination Center's telecommunication Network systems operate within but are not limited to Five direct communicable links. The First Three of Five links are direct links to and from the Dissemination Center and the individual and or multiple machines. The Fourth and Fifth of Five links are direct links to and from Four seperate entities and or contracted support services.

The First of Five communicable links is to and from the Dissemination Center and the Machine One and or the multiple individual machines via digital radio transmissions. The Second of Five communicable links is to and from the Dissemination Center and the machine 1 and or the multiple individual machines via Hard Lines and or Land Lines and or Fiber Optic telecommunications systems. The Third of Five communicable links is to and from the Dissemination Center and the Machine 1 and or the multiple individual machines via the internet modem connector The Fourth of Five communicable links is to and from the Dissemination Center and the NYSE and or the New York Stock Exchange, to and from the Center and the NASDAQ and or the NASDAQ Stock Exchange and to and from the Center and the AMEX and or the American Stock Exchange via contracted dispersed data services via Fiber Optic hard and or Land Lines. The Fifth of Five communicable links is to and from the Dissemination Center and a contracted, Federally Licensed and Insured International Brokerage House and or Stock Clearing House via Fiber Optic hard and or Land lines.

The Machine 1 and or the machine is a tool, a device for both the novelist and the professional investor This economic tool enables the “user” of the machine the unique opportunity to place Stock Trades with Three American Stock Exchanges, from most locations world-wide. Anytime of the day and or night, on any given day of the week the “user” of the machine can extract, depict, monitor, set Stock Trades (buy and or sell) and or set Limit Order Stock Trades with the NYSE, the NASDAQ and the AMEX Stock Exchanges. Geographically the “user” of the machine can trade shares of stocks world-wide and or anyplace within the range of the already in place and yet to be installed Global Network of Digital Radio Towers and or through any hard and or Land Line telecommunications network.

Legally only Licensed Brokerage Houses and or Stock Clearing Houses can purchase shares of stocks in America therefore, the Machine 1 and or the machine utilizes digital radio technology to signal the Machine 1 Dissemination Center's brick and mortar establishment that houses a Mainframe Computer Server's search engine for assistance through a direct fiber optic hard and or Land line link to a Federally Licensed and Insured, International Brokerage House and or Stock Clearing House. The Dissemination Center's search engine receives the Trade instructions via both and or wireless digital radio transmissions and or land line telecommunications systems then converts and or diverts the data to and or through Fiber Optic hard and or Land Lines directly linked to a Second Mainframe Computer System's program that is housed within the Brokerage House and or the Stock Clearing House. Overseen by a Broker, this Second Mainframe Computer Server's program is instructed by the First and or the Dissemination Center's Mainframe Computer server's program to Deposit and or Withdraw money from the “user” of the machine's adjoining Portfolio/Money Market fund accounts to cover the monetary aspects of Trading Shares of Stocks.

If and only if, any and or all financial responsibilities and or fiduciary obligations are met, then and only then will the Federally Licensed and Insured Broker place the Stock Trade directly to and from the “user” of the machine's personal Portfolio Account. Once the Stock Transaction and or the Stock Trade is complete and or has been executed the Second Mainframe. Computer Server's program located and or housed at the International Brokerage House signals the First Mainframe Computer Server's program located and or housed at the Machine 1 Dissemination Center of the completed and or executed transaction via Fiber Optic hard and or Land Lines.

The Machine 1 Dissemination Center records the said mentioned transaction within Two different records. The First of the Two records and or record One is stored, housed and maintained within the Dissemination Center's Database and or File Servers. The Second of Two records and or record Two is stored housed and maintained within the Machine 1 and or the machine's Portfolio Transaction Review Feature via digital radio transmissions.

During after Market Hours and or on all weekends and Federal Holidays all Stock Trade Orders will be held in limbo until such time as when the Markets open for Trading shares of listed company's stocks once again. Anytime prior to the Opening Bell and or a.m. 9:30 est. time the “user” of the machine can cancel the Stock Trade Order. Once the Opening Bell rings marking the beginning of the next live Market session, the Trade will automatically be Traded and or executed, at this time the Stock Trade Order cannot be withdrawn and or deleted.

Whenever the “user” of the machine presses certain key sequences on and or with the multi-functional Keyboard Keys, an instructional aid in the form of command instructions and or options will be shown, depicted and or displayed on the machine's viewing screen 4G. These instructions and or commands and or options are depicted embedded and or formatted on a Blue colored background illustrated with White Capital Letters, numbers and symbols. This programming and or instructional aid can be shown, displayed and or depicted in any One of Three languages, English, French and or Spanish. Computer program 1, part 3, Portfolio Programming is in essence the direct interaction between the “user” of the machine and the machine, ie the “user” of the machine tells the machine what to do via the multi-functional keyboard keys, then the machine does it.

Within the manuscript before you their is a section entitled programming, this section describes in detail the “user” of the machine's programming aspect concerning the machine's mechanical and or programming abilities. Once the “user” of the machine types commands into the machine, these commands are sequentially transformed into Computer program One part Three.

The Machine 1 Dissemination Center operates within a Five part program entitled Computer program One, parts One through Five. Part one of the Five part program collects economic data from Three contracted dispersed data services via Fiber Optic hard and or Land Lines. Part Two of the Five part program disperses this said mentioned economic data to the individual machines via wireless digital radio Burst technology. Part Three of the Five part program collects data being transmitted to and from the individual machines via wireless, digital radio transmissions. Part Four of this Five part program transmitts data from Computer program One part Four to Computer program Two located in the Mainfram Computer database server housed within the contracted Brokerage House via Fiber Optic hard and or Land Lines. Part Five of this Five part program collects and stores the economic data received from the Brokerage House's Computer program Two part Four via Fiber Optic hard and or Land Lines then transmitts the economic data to the individual machines utilizing Computer program One part Three via wireless, digital radio “Burst” transmissions. This Five part program is entitled Computer program One parts One through Five.

The Machine 1 and or the machine utilizes the contracted services of a Brokerage House and or a Stock Clearing House to buy and or sell (Trade) shares of stocks from and or with Three different U.S. Stock Exchanges, the NYSE, the NASDAQ and the AMEX. Housed within this contracted Brokerage House their is a Mainframe Computer,Server equiped with a search engine and a Four part Computer program that will be from here on after referred to as Computer program Two parts One through Four.

The First part of this Four part program has a database consisting of approximately Eighteen Hundred Stock Symbols extracted from the Three said mentioned stock exchanges. Each exchange is represented by a listing of the Top Six Hundred companies (according to Market Capitalization), listed with their exchange. Note, at this time the AMEX presently list approximately Five Hundred and Seventy Six companies. If and when this number surpasses Six Hundred, then and only then will the Top Six Hundred of these said mentioned companies be listed.

The “user” of the machine by ways and or means of the machine can Buy and or Sell (Trade) shares of any and or all of the approximately Eighteen Hundred exchange listed stock symbols filed and or listed within this database file and or record set. The Second part of this Four part program extracts economic data consisting of the Personal Portfolio/Money Market Fund accounts from and or of any and or all “users” of the machine and or the machines. The Third part of this Four part program (under the direct supervision of a licensed Broker) Buys and or Sells (Trades) shares of stock from and to the Three said mentioned exchanges. The Fourth part of this Four part program records any and or all stock exchange trading activity then relays the data back onto the Machine 1 Dissemination Center's Computer program One part Three via Fiber Optic hard and or Land Lines.

| | |
|---|---|
| AMEX | The American Stock Exchange |
| cac-40 | (Index) Paris France Stock Exchange |
| (.clz2) | (Comodity) Light, sweet crude oil |
| CRUDE | (Comodity) Brent North Sea Crude Oil |
| DJIA | (Index) The Dow Jones Industrial Average |
| euro | European currency |
| (.fpp) | (Index) Industrial paper |
| FTSE 100 | (Index) United Kingdom, Stock Exchange |
| GOLD | (Comodity) Future's contract |
| Hang Seng | (Index) Hong Kong Stock Exchange |
| MCTSFD | Multiple Catagory, Three Second Formatted |
| | Display. |
| NASDAQ | both a Composite Index and a Stock Exchange |
| Nikkei 225 | (Index) Japan's Stock Exchange |
| NYSE | The New York Stock Exchange |
| pound | England's currency |
| SILVER | (Comodity) Future's contract |
| SMTTFD | Stock Market Ticker Tape Formatted Display |
| (.soxx) | Philadelphia Semiconductor Index |
| S+P 500 | (Index) Standard and Poors Top 500 stocks |
| 2 yr. t-note | U.S. Government Treasury note |
| 5 yr. t-note | U.S. Government Treasury note |
| 10 yr. t-note | U.S. Government Treasury note |
| 30 yr. t-note | U.S. Government Treasury note |
| (.xal) | (Index) Top Commercial Airlines |
| xetra/DAX | (Index) Frankfurt Germany Stock Exchange |
| yen | Japan's currency |

In order to follow the Machine 1 and or the machine's operationg Instructions and or Instructional Guide the “user” of the machine should be versed in Market Hours. In other words Market Hours are the daily business hours in which the Three U.S. Stock Exchanges utilized by the machine are open for the business of Trading shares of listed company's stock. Market Hours operate within a time frame of and or from Opening Bell and or a.m. 9.:30 est. time through Closing Bell and or p.m. 4:00 est. time. Market Hours apply Monday through Friday except on Federal Holidays at which time the Markets and or Stock Markets are closed.

After Market Hours sessions operate within a time frame of and or from Closing Bell and or p.m. 4:00 est. time through and or until Opening Bell and or a.m. 9:30 est. time Monday through Friday. The after Market Hours sessions also applies to Twenty Fours hours of the day on all weekends and Federal Holidays.

On any given night prior to the opening of the Markets and or Sundays through Thursdays except prior to a Federal Holiday, between the hours of a.m. 12:00 est. time and or Midnight through and or until Opening Bell and or a.m. 9:30 est. time is referred to as both and or either after Market Hours and or pre Market Hours.

Any and or all after Market Hours Trading and or pre Market Hours Trading along with any and or all weekend and or Holiday Trading falls into the catagory known as Instanet Trading. The Machine 1 and or the machine operates only within the monitor position and or the monitor mode of operations during any and or all after Market Hours and or any and or all pre Market Hours sessions and or during the said mentioned Instanet Trading sessions.

Note, the machine, twice daily during Market Hours sounds a bell (audio), Five times in succession within a One point Five Second time frame, the First of Two times is at Opening Bell and or a.m. 9:30 est. time, the Second of Two times is at Closing Bell and or p.m. 4:00 est. time. This said mentioned audio feature will also sound whenever the machine is turned on and or off.

The Machine 1 and or the machine features Six different venues for simultaneous depictions of live, world wide economic data on Four individually named and numbered viewing screens and or windows. The First of Six venues of simultaneous depictions of live, world-wide economic data is formatted and or embedded within a color-coded MCTSFD type 1, type 2, type 3 and or type 4 on the machine's viewing screen 1A. The Second of Six venues of simultaneous depictions of live, world-wide economic data is formatted and or embedded within a MCTSFD type 5 on the machine's viewing screen 1B. The Third of Six venues of simultaneous depictions of live, world-wide economic data is formatted and or embedded within either a SMTTFD type 1, type 2, type 3 and or type 6 on the machine's viewing screen 2C. The Fourth of Six venues of simultaneous depictions of live, world-wide economic data is formatted and or embedded within either a color-coded SMTTFD type 1, type 2, type 3 and or type 6 on the machine's viewing screen 2D. The Fifth of Six venues of simultaneous depictions of live, world-wide economic data is formatted and or embedded within either a color-coded SMTTFD type 1, type 2, type 3 and or type 6 on the machine's viewing screen 3E. The Sixth of six venues of simultaneous depictions of live, world-wide economic data is formatted and or embedded within either a color-coded SMTTFD type 4, type 5 and or type 6 on the machine's viewing screen 3F.

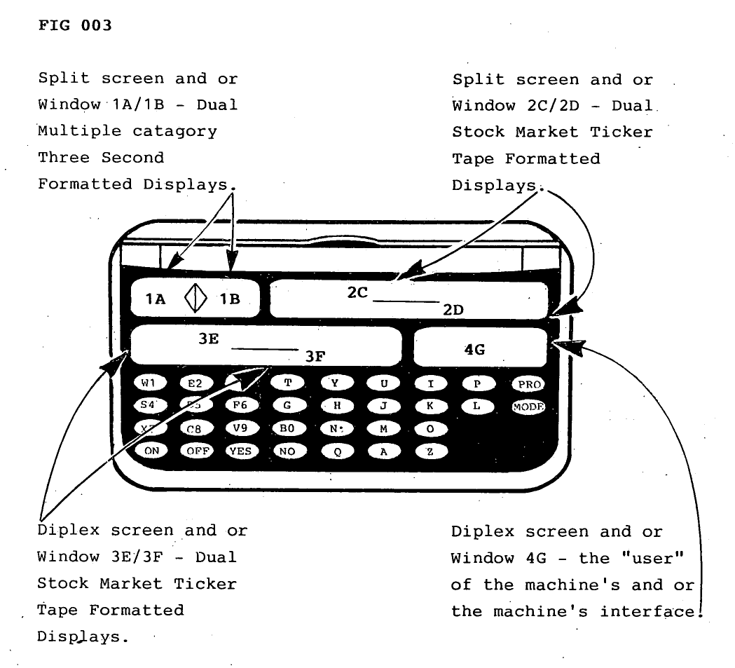

These Six fore-mentioned venues of simultaneous depictions of live, world-wide economic data are formatted and or embedded within either a color-coded MCTSFD type 1, type 2, type 3, type 4 and or type 5 on the machine's viewing screen 1A/1B along with Six different types of color-coded SMTTFD, Four types at the same time on Four individually named and numbered viewing screens and or windows 2C, 2D, 3E and 3F, (SEE FIG. 003).

The First of Four named and numbered viewing screens and or windows is located at the Top Left hand corner of the machine. This is viewing screen and or window 1A/1B. Viewing screen 1A/1B is a split action and or a dual action viewing screen that depicts either a color-coded MCTSFD type 1, type 2, type 3 and or type 4 on the Left hand side of this dual and or split viewing screen and or window 1A. The Right hand side of this dual and or split viewing screen and or window 1B depicts a color-coded MCTSFD type 5.

The Second of Four named and numbered viewing screens and or windows is located at the Top Right hand corner of the machine, (SEE FIG. 003). This viewing screen and or window is named and numbered viewing screen and or window 2C/2D. Viewing screen 2C/2D is a dual action and or a split action viewing screen and or window that depicts either a color-coded SMTTFD type 1, type 2, type 3 and or type 6 on the Top half of this dual action and or split action viewing screen and or window 2C. Viewing screen 2C/2D depicts either a color-coded SMTTFD type 1, type 2, type 3 and or type 6 on the Bottom half of this dual and or split action viewing screen and or window 2D.

The Third of Four named and numbered viewing screens and or windows is located at the Bottom Left hand corner of the machine, (SEE FIG. 003). This viewing screen and or window is named and numbered viewing screen and or window 3E/3F. Viewing screen 3E/3F is a dual and or diplex action viewing screen and or window that depicts either a SMTTFD type 1, type 2, type 3 and or type 6 on the Top half of this dual and or diplex action viewing screen and or window 3E. Viewing screen 3E/3F depicts either a SMTTFD type 4, type 5 and or type 6 on the Bottom half of this dual and or diplex action viewing screen and or window 3F.

The Fourth of Four named and numbered viewing screens and or window 4G. Viewing screen 4G is the “user” of the machine's interface and or the Machine 1 and or the machine's command center. Viewing screen and or window 4G depicts instructional aids and or operating instructions and or any and or all modes of operation, including but not limited to any and or all economic data pertaining to the “user” of the machine's Personal Portfolio/Money Market Fund accounts.

In retrospect and conclusion the Machine 1 and or the machine features Six venues for simultaneous depictions of live, world-wide economic data formatted and or embedded within Four individually named and numbered viewing screens and or windows 1A/1B, 2C/2D, 3E/3F and 4G.

For an illustration of the Machine 1 and or the machine depicting a sample and or an example of economic data on all Four viewing screens and or windows, (SEE FIG. 001).

Viewing screen and or window 1A, (SEE FIG. 001 and FIG. 003), is either a MCTSFD type 1, type 2, type 3 and or type 4 that depicts Twenty individual indexs, One at a time, rotating within a Twenty segment and or Twenty records, Three Seconds per segment and or record, Sixty Second rotation cycle.

Viewing screen and or window 1B, (SEE FIG. 001 and FIG. 003), depicts Three individual indexs, One at a time, rotating within a Three segment and or record, Three Seconds per segment and or record, Nine Second rotation cycle.

Viewing screen and or window 2C, (SEE FIG. 001 and FIG. 003), depicts either a:SMTTFD type 1, type 2, type 3 and or type 6 formatted and or embedded with Stock Symbols extracted from the NYSE's BIG BOARD of Trades. These Stock symbols will be scrolling within a Six Hundred segment and or record, One point Five Seconds per segment and or record, Fifteen Minute rotation cycle.

Viewing screen and or window 2D, (SEE FIG. 001 and FIG. 003), depicts either a SMTTFD type 1, type 2, type 3 and or type 6 formatted and or embedded with Stock Symbols extracted from the NASDAQ's BIG BOARD of Trades. These Stock Symbols will be scrolling within a Six Hundred segment and or record, One point Five Seconds per segment and or record, Fifteen Minute rotation cycle.

Viewing screen and or window 3E, (SEE FIG. 001 and FIG. 003), depicts either a SMTTFD type 1, type 2, type 3 and or type 6 formatted and or embedded with Stock Symbols extracted from the AMEX's BIG BOARD of Trades. These Stock Symbols will be scrolling within a Six Hundred segment and or record, One point Five Seconds per segment and or record, Fifteen Minute rotation cycle during the hours of a.m. 9:30 est. time through and or until p.m. 4:00 est. time. During the after Market Hours sessions viewing screen and or window 3E, (SEE FIG. 001 and FIG. 003), will depict a SMTTFD type 1 formatted and or embedded with a combination of NYSE and NASDAQ listed Stock Symbols actively being traded live at the Instanet Trading Floor This SMTTFD type 1 scrolls within a Six Hundred segment and or record, One point Five Seconds per segment and or record, Fifteen Minute rotation cycle.

Viewing screen and or window 3F, (SEE FIG. 001 and FIG. 003), depicts either a SMTTFD type 4, type 5 and or type 6 formatted and or embedded with Stock Symbols extracted from the “user” of the machine's Customized, Personal Portfolio and or extracted from either the NYSE, the NASDAQ and or the AMEX's BIG BOARD of Trades. Any One and or a combination of Two and and or Three U.S. Stock Exchanges scrolling within a Six Hundred segment and or record, One point Five Seconds per segment and or record, rotation cycle.

Viewing screen and or window 4G, (SEE FIG. 001 and FIG. 003), is the “user” of the machine's interface and or the machine's command center.

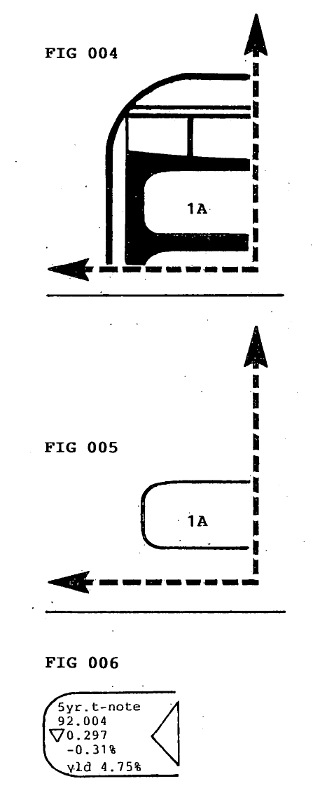

(SEE FIG. 004), this is a depiction of the Left-hand side of viewing screen and or window 1A/1B and or specifically viewing screen and or window 1A. (FIG. 004) is a partial view of (FIG. 003), for a removed view of (FIG. 004), (SEE FIG. 005). (FIG. 005) is an enlarged sectional view of (FIG. 004).

Viewing screen and or window 1A and or the left-hand side of the split action viewing screen and or window 1A/1B depicts extracted economic data from Twenty individual indexs, One at a time. The color-coded symbols, letters and numbers are depicted rotating within a Sixty Second, Twenty segment and or record, rotation cycle. Each segment and or record depicts from One to Six catagories and or fields of economic data for Three Seconds per segment and or record.

During Market Hours, once the Sixty Second rotation completes the pre-programmed cycle all of the depicted economic data is instantaneously updated and the sequence of new and or updated economic data begins. During the after Market Hours sessions the Closing Bell and or the p.m. 4:00 est. time values are reiterated until such time as when the Markets open for the business of Trading shares of listed company's stock, once again.

For an overview and or an illustration depicting the catagories and or fields of economic data, (SEE FIG. 006). Note, If the Index's averaged value is up the symbols, letters and numbers will be depicted in the color Green. If the Index's averaged value is down the symbols, letters and numbers will be depicted in the color of Red.

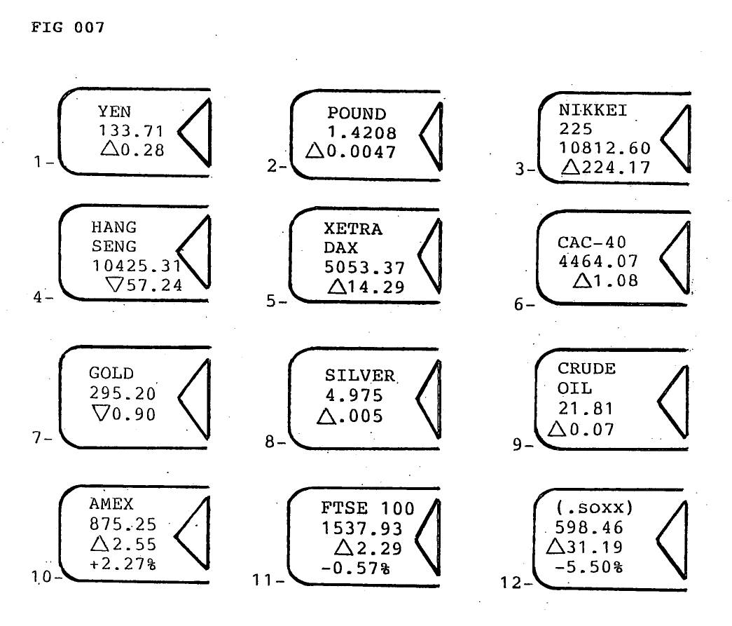

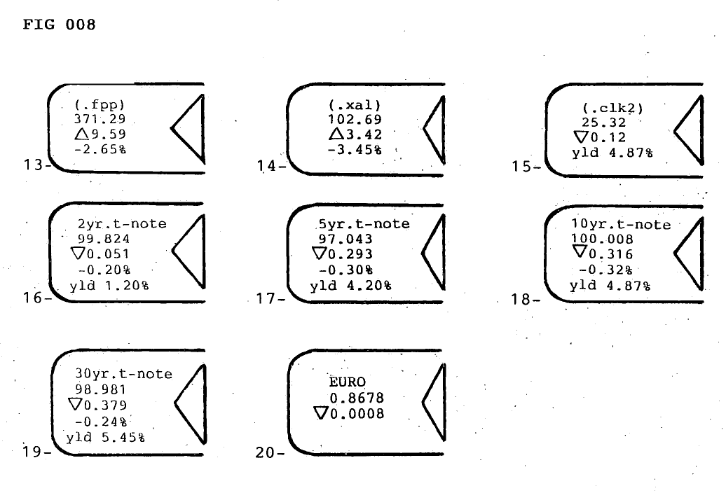

For an illustration and or a depiction of example and or a sample of economic data pertaining to and or embedded within the Twenty individual Indexs depicted positioned within the pre-determined rotation order, (SEE FIG. 007 and FIG. 008). The rotation cycle ends here at station and or record Twenty. The machine will now instantaneously update the fields of economic data, the new updated fields of data will now begin the Sixty Second rotation cycle.

During Market Hours and or from a.m 9:30 est. time through and or until p.m. 4:00 est. time, Monday through Friday, except on Federal Holidays the depicted economic data is updated at the end of each Sixty Second rotation cycle. During after Market Hours the p.m. 4:00 est. time price and or value is reiterated at the end of each Sixty Second rotation cycle.

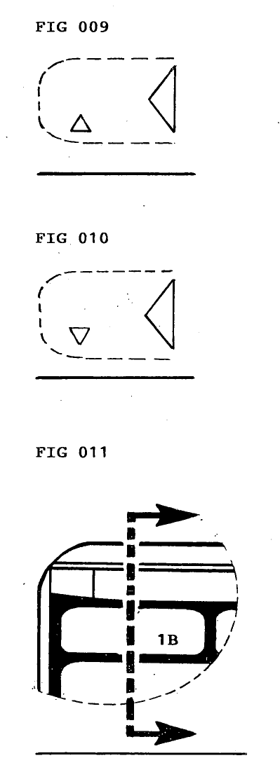

(SEE FIG. 009), these Two color-coded symbols indicate that the Market, Exchange, Composite, Commodity, Index and or currency is up in overall value. Note, this is a Black and White depiction, the true color of these Two symbols is Green.

(SEE FIG. 010), These Two color-coded symbols indicate that the Market, Exchange, Composite, Commodity, Index and or currency is down in overall value. Note, this is a Black and White depiction, the true color of these Two symbols is Red.

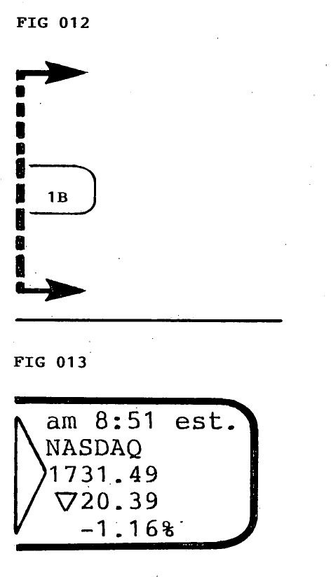

(SEE FIG. 011), this is a partial view of (SEE FIG. 003). For a removed view of (FIG. 011), (SEE FIG. 012). (FIG. 012) is a removed sectional view of (FIG. 011).

Viewing screen and or window 1B and or the Right-hand side of the split action viewing screen and or window 1A/1B depicts extracted economic data from Three individual indexs, One at a time. The color-coded symbols, letters and numbers are depicted rotating within a Three segment and or record, Three Seconds per segment and or record, Nine Second rotation cycle. Each of the Three segments and or records depicts Eight catagories and or fields of economic data.

During Market Hours, once the Nine Second rotation completes the pre-programmed cycle, the depicted economic data is instantaneously updated and the sequence of new and or updated economic data begins the Nine Second, Three record, rotation cycle. During the after Market Hours sessions the Closing Bell and or the p.m. 4:00 est. time values are reiterated until such time as when the Markets open for the business of Trading shares of listed company's stock, once again.

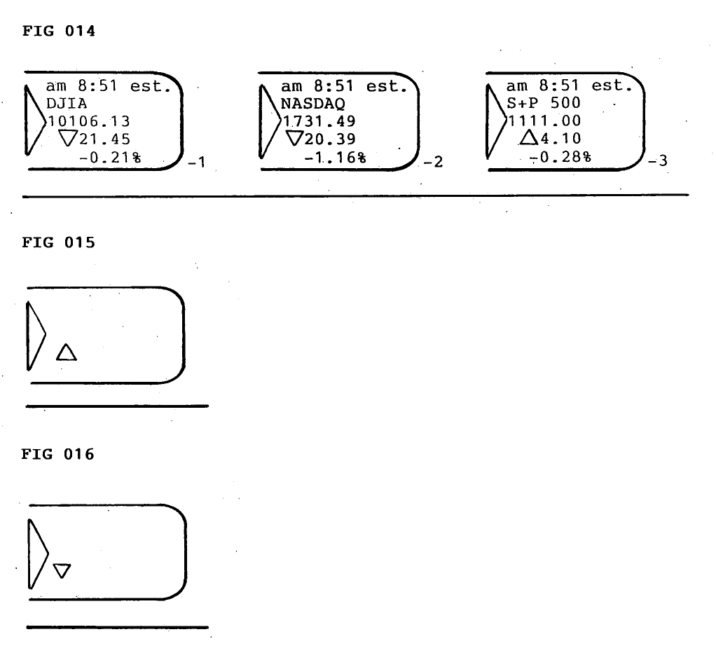

For an overview and or an illustration of viewing screen and or window 1B depicting the catagories and or fields of economic data (SEE FIG. 013). For a depiction and or an illustration of the machine's viewing screen and or window 1B depicting the Three individual, said mentioned institutions along with examples and or samples of the accompanying economic data, (SEE FIG. 014). The rotation ends here at station and or record Three. The machine will now instantaneously update the fields of economic data, the new updated fields of data will now begin the Nine Second rotation cycle.

Note, during the hours of a.m. 9:30 est. time through and or until p.m. 4:00 est. time the fields of economic data are updated at the end of each Nine Second rotation cycle. More, during the hours of p.m. 4:00 est. time through and or until a.m. 9:30 est. time, the Closing Bell values are reiterated throughout the night and or until the a.m. 9:30 est. time Opening bell of the next live Market session.

(SEE FIG. 015 and FIG. 016), their are Two color-coded symbols in each of the displays and or figures. When the Two symbols depicted in (SEE FIG. 015) appear and or are depicted they will be illustrated in the color of Green, this signifies to the “user” of the machine that the financial institution's economic data being depicted is currently up in overall value.

Likewise, when the Two symbols depicted in (SEE FIG. 016) appear and or are depicted they will be illustrated in the color of Red, this signifies to the “user” of the machine that the financial institution's economic data currently being depicted is down in overall value.

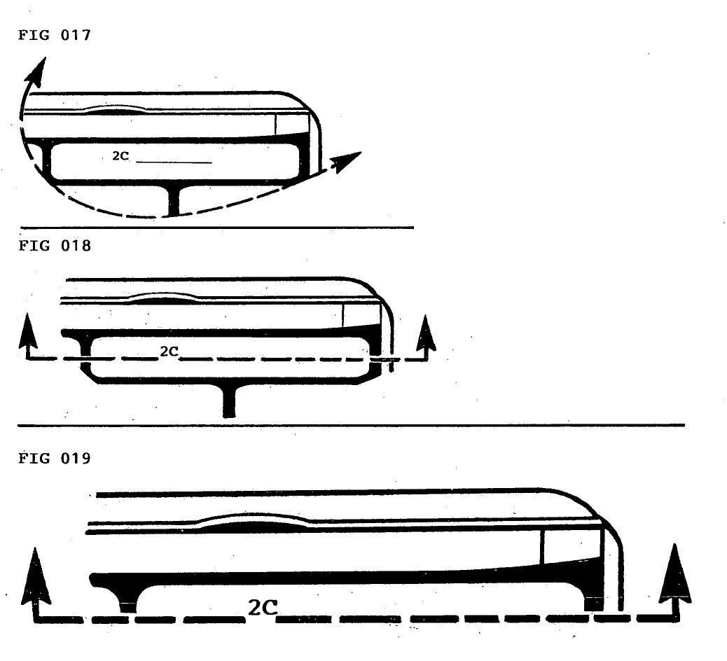

(SEE FIG. 017) this is a partial view of (SEE FIG. 003). (SEE FIG. 018) this is a sectional view of (SEE FIG. 003). (SEE FIG. 019) this is a removed sectional view of (SEE FIG. 003).

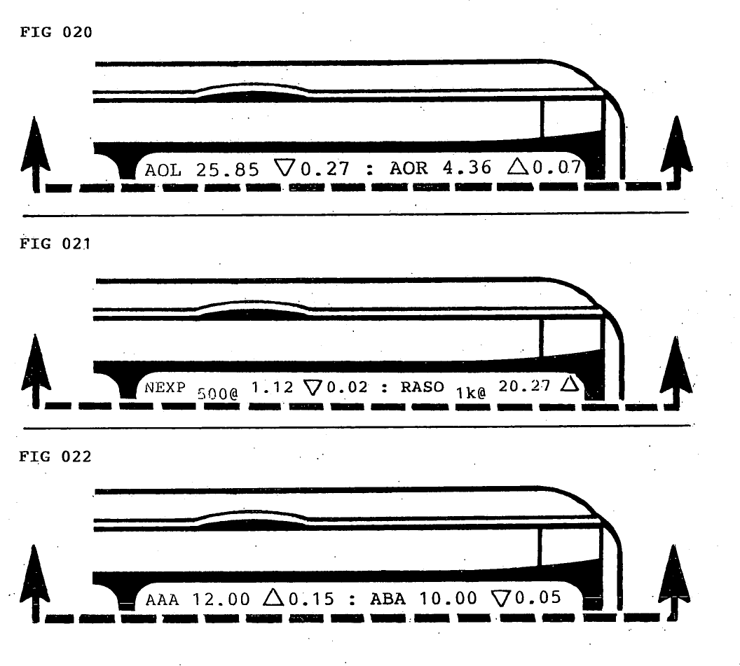

(SEE FIG. 019 and FIG. 020) for an illustration and or a removed sectional view of the machine's viewing screen and or window 2C. (SEE FIG. 020) this is an illustration of the machine's viewing screen and or window 2C depicting an after Market hours SMTTFD type 3.

From Closing Bell and or from p.m. 4:00 est. time through and or until Opening Bell and or a.m. 9:30 est. time, NYSE listed Stock Symbols along with the said mentioned symbol's per share price is depicted prior to either an inverted and or an upright positioned pyramid shaped symbol followed by the said mentioned stock shares daily change in the per share price.

An after Market Hours SMTTFD type 3 is an A through Z, Alphabetical Order rotation cycle that depicts dormant, color coded symbols, ltters and numbers scrolling from Right to Left, embedded within a Six Hundred Stock Symbol, One point Five Seconds per symbol, Fifteen Minute rotation cycle.

The NYSE and or the New York Stock Exchange presently list approximately Four Thousand One Hundred company's stock symbols, the Machine 1 and or the machine extracts the Top Six Hundred of these company symbols (according to Market Capitalization).

During the after Market Hours session, the p.m. 4:00 est. time Closing Bell prices are depicted embedded within a SMTTFD type 3. The values and or per share prices will be reiterated throughout the session until such time as when the

Markets Open for the Business of Trading Shares of Listed Company's Stock, Once Again.

The last rotation cycle prior to the Opening Bell and or at a.m. 9:15 est. time, the machine's viewing screen and or window 2C's depiction of NYSE listed stock symbols formatted and or embedded within a SMTTFD type 3 will be replaced by and or with the same NYSE listed stock symbols formatted and or embedded within a SMTTFD type 6. A SMTTFD type 6 depicts dormant, NYSE listed stock symbols that are color-coded with White colored letters, numbers and symbols formatted and or embedded within and or on a colored Blue background. The said mentioned dormant stock symbols depict the p.m. 4:00 eastern time Closing Bell prices posted at the end of the last live Market session. At Opening Bell and or at a.m. 9:30 est. time the SMTTFD type 6 being depicted on the machine's viewing screen and or window 2C will be replaced by and or with the same NYSE listed stock symbols depicted embedded with either a SMTTFD type 1 and or a SMTTFD type 2 depending upon the machine's Market Shift position and or Mode of operation.

When the Machine 1 and or the machine's viewing screen and or window 2C is depicting NYSE Stock Symbols formatted and or embedded within a SMTTFD type 1 the Stock Symbols are randomly depicted scrolling within a Live trades, trade by trade, depicted as listed, buy and or sell SMTTFD. For an illustration of a SMTTFD type 1 depicted embedded within a sectional view of viewing screen and or window 2C, (SEE FIG. 021).

During Market Hours and or from a.m. 9:30 est. time through and or until p.m. 4:00 est. time, on a White colored background, scrolling from Right to Left, real time, live trades are depicted embedded within a SMTTFD. When any given stock is up in overall value the symbols, letters and numbers associated with it shall be the color Green. More, when the symbols, letters and numbers are depicted in the color Red this means and or indicates that the depicted stock is down in overall value. Even more, when the symbols, letters and numbers are colored Blue this means and or indicates that the particular stock symbol is still trading at and or back to the Opening Bell price of the stock.

When the machine's viewing screen and or window 2C is depicting NYSE listed Stock Symbols formatted and or embedded within a SMTTFD type 2 the stock symbols are depicted Live in an A through Z, Alphabetical Order, Six Hundred Stock symbol display. Each NYSE listed stock symbol is depicted for One point Five Seconds of display time per fifteen Minute rotation cycle. Any and or all of the economic data associated with and or pertaining to the listed stock symbols is updated at the end of each rotation cycle and or Once every Fifteen Minutes during normal Market Hours. For an illustration of a SMTTFD type 2 depicting NYSE listed stock symbols formatted and or embedded within an enlarged, removed sectional view of the machine's viewing screen and or window 2C, (SEE FIG. 022).

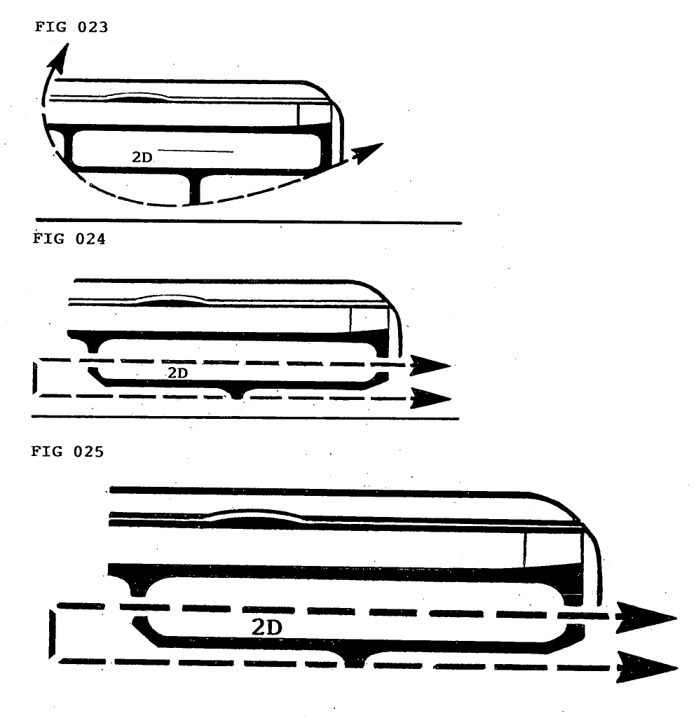

(SEE FIG. 023), depicted is a partial view of (SEE FIG. 003). (SEE FIG. 024), depicted is a sectional view of (SEE FIG. view of (SEE FIG. 003). (SEE FIG. 025), depicted is an illustration of the machine's viewing screen and or window 2D.

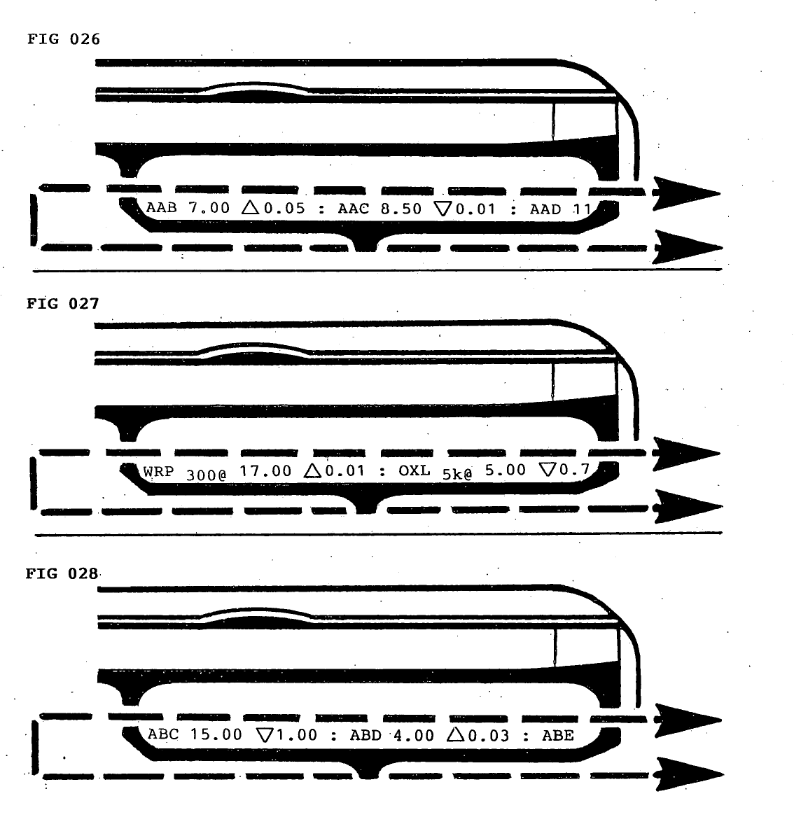

Viewing screen and or window 2D is identical in function and format as screen and or window 2C, the One difference between the Two SMTTFD is the economic data scrolling along embedded within the SMTTFD. Viewing screen and or window 2D features the NASDAQ and or the NASDAQ Stock Exchange's listed stock symbols, (SEE FIG. 026). The machine 1 and or the machine's viewing screen and or window 2D is depicting an after Market Hours SMTTFD type 3.

From Closing Bell and or p.m. 4:00 est. time through and or until Opening Bell and or a.m. 9:30 est. time, NASDAQ listed stock symbols along with the said mentioned symbol's per share price is depicted prior to either an inverted and or an upright positioned pyramid shaped symbol followed by the said mentioned stock symbols daily change in the per share price.

An after Market Hours SMTTFD type 3 is an A through Z, Alphabetical Order rotation cycle that depicts dormant, color coded symbols, letters and numbers'scrolling from Right to Left formatted and or embedded within a Six Hundred stock symbol, One point Five Seconds per symbol, Fifteen Minute rotation cycle.

The NASDAQ Stock Exchange list approximately Three Thousand Six Hundred company's Stock symbols, the Machine 1 and or the machine extracts the Top Six Hundred of these exchange listed stock symbols (according to Market Capitalization).

During the after Market Hours sessions the p.m. 4:00 est. time Closing Bell prices posted at the end of the last live Market session are depicted, formatted and or embedded within a SMTTFD type 3. The posted values will be reiterated throughout throughout the after Market Hours session and or until such time as when the Markets open for the business of Trading shares of listed company's stock, once again.

The last rotation cycle prior to the Opening Bell and or at a.m. 9:15 est. time, the machine's viewing screen and or window 2D's depiction of NASDAQ exchange listed stock symbols formatted and or embedded within a SMTTFD type 3 will be replaced by and or with the same NASDAQ exchange listed stock symbols formatted and or embedded within a SMTTFD type 6.

A SMTTFD type 6 depicts NASDAQ exchange listed stock symbols color-coded with White letters, numbers and symbols formatted and or embedded within and or on a colored Blue background. These said mentioned stock symbols depict dormant economic data consisting of the exchange listed stock symbol along with the last active and or live per share price posted at the end of the last live Market session.

At Opening Bell and or at a.m. 9:30 est. time the SMTTFD type 6 being depicted on the machine's viewing screen and or window 2D will be replaced by and or with the same NASDAQ exchange listed stock symbols formatted and or embedded within either a SMTTFD type 1 and or a SMTTFD type 2 depending on the machine's Market Shift position and or Mode of operation.

When the Machine 1 and or the machine's viewing screen and or window 2D is depicting NASDAQ exchange listed stock symbols formatted and or embedded within a SMTTFD type 1 the stock symbols are randomly depicted within a Live Trades, trade by trade, depicted as listed, buy and or sell SMTTFD. For an illustration of a SMTTFD type 1 depicted, formatted and or embedded within a removed sectional view of the machine's viewing screen and or window 2D, (SEE FIG. 027).

During Market Hours and or from a.m. 9:30 est. time through and or until p.m. 4:00 est. time, on a White colored background, scrolling from Right to Left, real time, Live Trades are depicted as follows, when a particular stock is up in overall value the symbols, letters and numbers associated with the given symbol shall be colored Green. More, colored Red economic data means that the depicted'stock is down in overall value and colored Blue economic data means and or indicates that the particular and or depicted stock symbol is still at and or back to the Opening Bell price of the stock.

When the machine's viewing screen and or window 2D is depicting NASDAQ exchange listed stock symbols formatted and or embedded within a SMTTFD type 2the stock symbols are depicted Live, in an A through Z, Alphabetical Order, Six Hundred stock symbol display. Each stock symbol is depicted for One point Five Seconds of display time per Fifteen Minute rotation cycle. Any and or all of the economic data pertaining to the particular stock symbols is updated at the end of each rotation cycle and or Once every Fifteen Minutes during normal Market hours. For an illustration of a SMTTFD type 2 depicted embedded within a removed sectional view of the machine's viewing screen and or window 2D, (SEE FIG. 028).

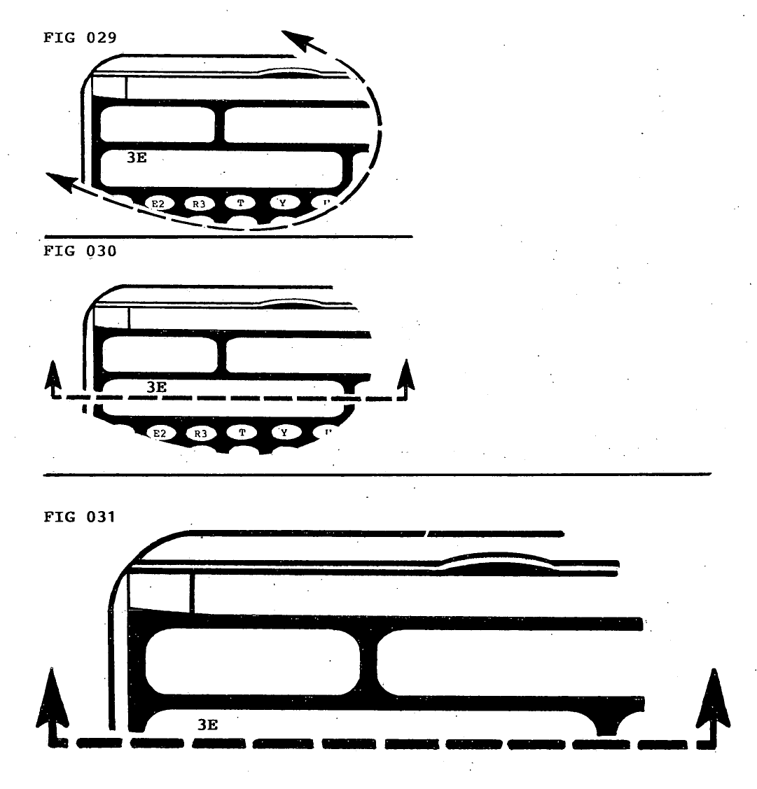

(SEE FIG. 029), depicted is a partial view of (SEE FIG. 003). (SEE FIG. 030), depicted is a sectional view of (SEE FIG. 003). (SEE FIG. 031), depicted is an enlarged, removed sectional view of (SEE FIG. 003). (SEE FIG. 031), depicted is an illustration of the machine's viewing screen and or window 3E.

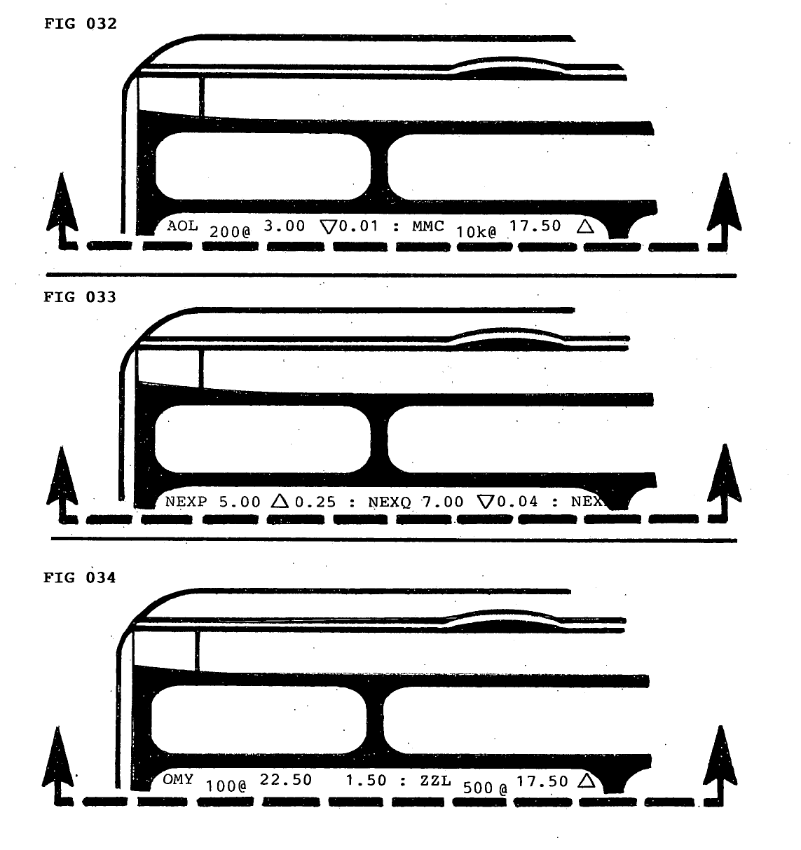

The Machine 1 and or the machine's viewing screen and or window 3E is identical in function and format as the machine's viewing screen and or windows 2C and 2D. The One significant difference is the depicted economic data. The machine's viewing screen and or window 3E features stock symbols extracted from the AMEX and or the American Stock Exchange during Market Hours and or from a.m. 9:30 est. time trough and or until p.m. 4:00 est. time. These AMEX exchange listed stock symbols will be formatted and or displayed embedded within either a SMTTFD type 1 and or a SMTTFD type 2 depending upon the Market Shift feature and or Mode of operation. (SEE FIG. 032) for an illustration of a removed sectional view depicting the machine's viewing screen and or window 3E formatted with a SMTTFD type 1.

When the Machine 1 and or the machine's viewing screen and or window 3E is depicting AMEX exchange listed stock symbols formatted and or embedded within a SMTTFD type 1 the stock symbols are randomly depicted within a Live Trades, trade by trade, depicted as listed, buy and or sell, SMTTFD.

During Market Hours and or between the hours of a.m. 9:30 est. time through and or until p.m. 4:00 est. time, real time, Live Trades are depicted embedded and or formatted scrolling from Right to Left on a White colored background. When any given stock is up in overall value and or price the symbols, letters and numbers associated and or depicted with the particular stock symbol shall be colored Green. When any given stock is down in overall value and or price the symbols, letters and numbers associated and or depicted with the particular stock symbol shall be colored Red. When any given stock is still at and or back to the a.m. 9:30 est. time Opening Bell price the symbols, letters and numbers associated and or depicted with the particular stock symbol shall be colored Blue.

When the machine's viewing screen and or window 3E is depicting AMEX exchange listed stock symbols formatted and or embedded within a SMTTFD type 2 the stock symbols are depicted Live, in real time,embedded within an A through Z, Alphabetical Order, Five Hundred Seventy Six stock symbol display. Each of the exchange listed stock symbols are depicted for One point Five Seconds of display time per rotation cycle. Any and or all of the economic data pertaining to and or associated with the depicted stock symbols shall be updated at the end of each rotation cycle during normal Market Hours. For an illustration of a SMTTFD type 2 depicted and or formatted embedded within a sectional view of viewing screen and or window 3E, (SEE FIG. 033).

The Machine 1 and or the machine's viewing screen and or window 3E as said mentioned depicts the AMEX and or the American Stock Exchange's listed stock symbols during Market Hours. During the after Market Hours sessions the machine's viewing screen 3E depicts Live, after Market Hours Stock Trades and or Trading from the Instanet Trading Floor embedded within a SMTTFD type 1.

This said mentioned Instanet Trading Floor's Live SMTTFD type 1 depicts a combination of NYSE and NASDAQ exchange listed stock symbols formatted and or displayed on the machine's viewing screen and or window 3E during all after Market Hours sessions. The “user” of the machine can monitor these Live, Instanet Trading Floor's stock trades and or Trading. The “user” of the machine cannot Trade shares of stocks with the machine and or with the Instanet stock exchange during these after Market Hours sessions. For an illustration of an enlarged sectional view of the machine's viewing screen and or window 3E depicting Live, Instanet Trading and or stock trades during the after Market Hours sessions, (SEE FIG. 034).

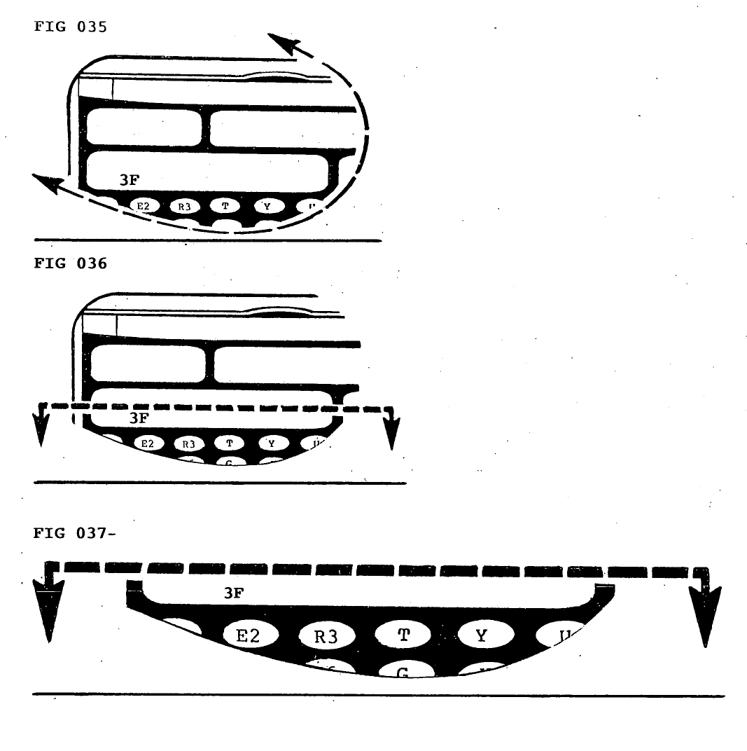

(SEE FIG. 035), depicted is a partial view of (SEE FIG. 003). (SEE FIG. 036), depicted is a sectional view of (SEE FIG. 003). (SEE FIG. 037), depicted is an enlarged sectional view of (SEE FIG. 003). (SEE FIG. 037), depicted is an illustration of the machine's viewing screen and or window 3F.

The machine 1 and or the machine's viewing screen and or window 3F is,the “user” of the machine's Customized, Personal Portfolio feature. This feature enables the “user” of the machine the unique ability to extract, depict, monitor, track, set limit orders and trade (buy and or sell) shares of stocks with Three U.S. Stock Exchanges, the NYSE, the NASDAQ and the AMEX.

Depending upon the time of day, the Machine 1's portfolio feature and or the machine's viewing screen and or window 3F will depict One of Two different types of SMTTFD. During Market Hours and or from Opening Bell and or from a.m. 9:30 est. time through and or until Closing Bell and or p.m. 4:00 est. time, the machine's viewing screen and or window 3F will depict a customized combination and or array of Live, continuously updated, “user” of the machine selected and or programmed stock symbols from any One of and or Two of and or all Three different said mentioned U.S. Stock Exchanges formatted and or embedded within a SMTTFD type 4. During after Market Hours and or from Closing Bell and or from p.m. 4:00 est. time through and or until Opening Bell and or a.m. 9:30 est. time, Monday through Friday, including Twenty Four hours of the day on all weekends and or Federal Holidays the machine's viewing screen and or window 3F will depict a customized, said mentioned combination and or array of now dormant, “user” of the machine selected stock symbols extracted from any One and or Two and or all Three different U.S. Stock Exchanges formatted and or embedded within a SMTTFD type 5.

The machine 1 and or the machine's customized personal portfolio feature enables the “user” of the machine the unique ability to extract from as few as One share of One company's stock to as many as Ninety Nine Thousand Nine Hundred Ninety Nine shares of up to Six Hundred different listed company's stock symbols from as few as One Stock Exchange to as many as and or a combination of up to Three U.S. Stock Exchanges.

The machine's viewing screen and or window 3F depicts the Three said mentioned U.S. Stock Exchanges formatted and or embedded within a pre-determined rotation order depicted within the same and or One long String of characters.

This said mentioned same and or One long String of characters and or Position One of a Three position String of characters and or the First of Three depicted and or listed U.S. Stock Exchanges will be the NYSE and or the New York Stock Stock Exchange along with any and or all programming and or stock symbols and any and or all accompanying economic data will be depicted, formatted and or embedded within either a Live SMTTFD type 4 and or a dormant SMTTFD type 5.

Position Two of the Three position String of characters and or the Second of Three depicted and or listed exchanges will be reserved for the NASDAQ and or the NASDAQ Stock Exchange along with any and or all programming and or stock symbols including any and or all accompanying economic data will be depicted, formatted and or embedded within either a Live SMTTFD type 4 and or a dormant SMTTFD type 5.

Position Three of the Three position String of characters and or the Third of Three depicted and or listed exchanges will be reserved for the AMEX and or the American Stock Exchange along with any and or all programming and or stock symbols including any and or all accompanying economic data will be depicted, formatted and or embedded within either a Live SMTTFD type 4 and or a dormant SMTTFD type 5.

The “user” of the machine utilizes the multi-functional Keyboard Keys to self-program the NYSE, the NASDAQ and or the AMEX exchange listed stock symbols into the customized, personal portfolio feature. Once typed and or programmed into the machine's customized, personal portfolio feature, color-coded symbols, letters and numbers will appear and or be depicted on and or embedded within either a Live SMTTFD type 4 and or a dormant SMTTFD type 5 onto the machine's viewing screen and or window 3F.

The exchange listed stock symbols are formatted and or embedded within an A through Z, Alphabetical rotation order depicted in a String of characters consisting of from as few as Four to as many as Six letters within parenthesis followed by a blank space and then from as few as One to as many as Six letters then a Second blank space followed by a dollar amount then a Third blank space followed by a symbol then a Fourth blank space followed by a lesser dollar ammount.

The First Four to Six letters within parenthesis is an acronym for the depicted and or listed U.S. Stock Exchange. The next set and or the following One to Six letters is an acronym for the depicted exchange's listed company's name and or stock symbol. The First and most formidable dollar ammount and or monetary figure represents the present and or current monetary value and or price of and or for One share of the depicted company's stock. Next, the “user” of the machine will see a small pyramid shaped symbol depicted either in an upright and or an inverted position. When the pyramid shaped symbol is depicted in an upright position this means and or indicates that the monetary value of the said mentioned depicted company's stock shares are currently up in overall monetary value and or per share price. When the pyramid shaped symbol is depicted within an inverted position this means and or indicates that the overall monetary value of the said mentioned and or depicted company's stock shares are currently down in value and or the per share price. Directly following after the pyramid shaped symbol the “user” of the machine will see a lesser dollar ammount and or monetary figure representing the daily change in the said mentioned Exchange listed company's per share stock price.

These color-coded symbols, letters and numbers are depicted and or illustrated within either the color of Red, Green, Blue and or White. When the code and or the String of characters is depicted and or illustrated in the color of Red this means and or indicates that the value and or the per share price of the given company's stock is currently down in value and or price. When the color-code and or the String of characters is depicted and or illustrated in the color of Green this means and or indicates that the value and or the per share price of the given company's stock is currently up in overall value and or price. When the color code and or String of characters is depicted and or illustrated in the color of Blue this means and or indicates that the per share price of the depicted company's stock is currently and or Once again trading at the a.m. 9:30 est. time Opening Bell posted value and or price. When the color-code is depicted and or illustrated in the color of White this means and or indicates that the time of day is between the hours of a.m. 9:15 est. time through and or until a.m. 9:30 est. time. The Markets are about to open, the machine 1 and or the machine is clearing and or deleting the daily change in the per share prices to make room for the upcoming Opening Bell and or the a.m. 9:30 est. time values and or prices.

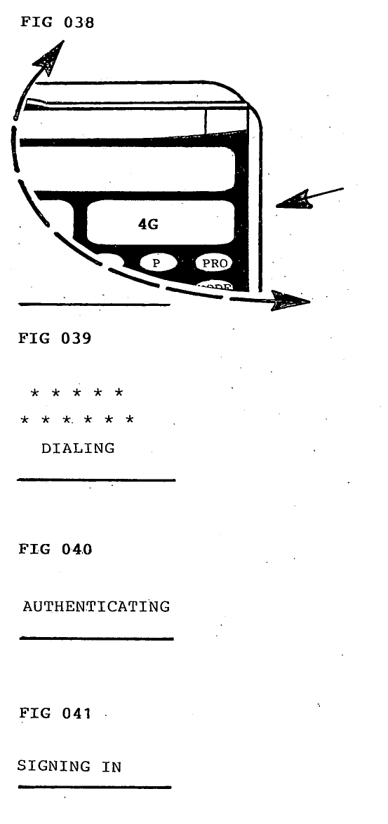

For a partial view of FIG. 003, (SEE FIG. 038). FIG. 038 is an illustration of the machine's viewing screen and or window 4G. The “user” of the machine's interface with the machine and or the Machine 1 Command Center. The machine's viewing screen and or window 4G visually depicts any and or all loading and or deleting command instructions and or Trading options via the multi-functional Keyboard Keys. The Tri-lingual keyboard activated command center can translate and depict operating and or stock trading instructions and or commands in any One of Three languages, English, Spanish and or French.

| Portfolio programming - | page |
|---|---|
| Machine 1 (on/off) | 166 |
| NYSE Stock Symbols/Monitor | 168 |
| NYSE Stock Symbols/Limit Order Stock Trades | 172 |
| NYSE Stock Symbols/Buy and sell Stock Trades | 175 |
| NYSE Stock Symbols/Stock Trades (records) | 176 |
| NYSE Stock Symbols/(Monitor (revisited) | 177 |
| NASDAQ Stock Symbols/Limit Order Stock Trades | 178 |
| AMEX Stock Symbols/Buy - Stock Trades | 181 |
| Modes of operation (overview) | 183 |
| Mode 2 of 4/Portfolio Transaction Review | 186 |
| AMEX Stock Symbols (delete) | 189 |
| Mode 3 of 4/Market Shift | 191 |
| Market Shift (overview (revisited) | 192 |
| Language capabilities (overview) | 198 |
| Mode 4 of 4/Language capabilities | 199 |

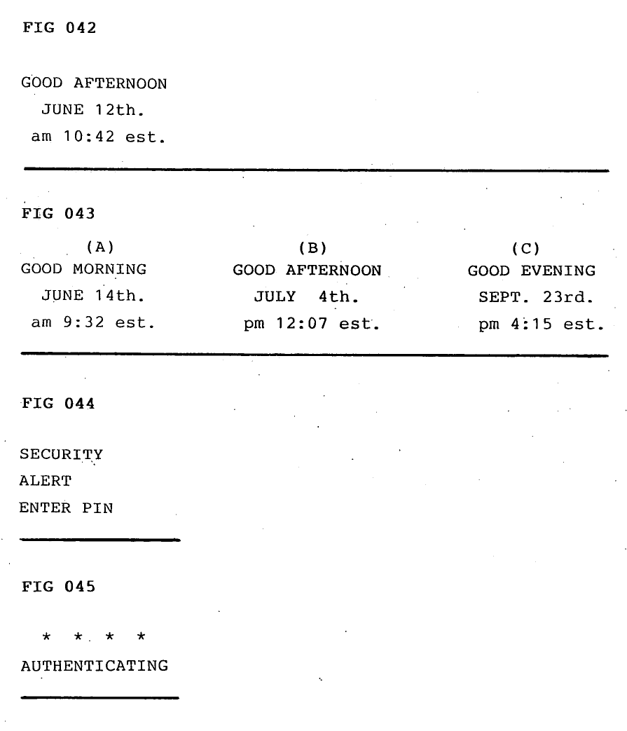

To begin, push the ON key and (SEE FIG. 039). FIG. 039 will be depicted on viewing screen and or window 4G for Three Seconds then (SEE FIG. 040). FIG. 040 will be depicted on viewing screen and or window 4G for Three Seconds then (SEE FIG. 041). FIG. 041 will be depicted on viewing screen and or window 4G for Three Seconds then (SEE FIG. 042). FIG. 042 will be depicted on viewing screen and or window 4G.

A bell (audio) will soud Five times in succession over a One point Five Second interval of time, this is a simulation of the Opening bell cerimonies that take place each morning at the NYSE. All viewing screens and or windows are up and running, screens and or windows 1A/1B, 2C/2D and 3E depict data scrolling and rotating. Viewing screen and or window 3F, the portfolio feature, depicts One, solid, White colored line and or horizontal bar pulsating on and off in One Second intervals. Note and or more, depending on the time of day One of Three pre-programmed greetings will be depcted on viewing screen and or window 4G, (SEE FIGS. 043 A, B and C) then (SEE FIG. 042).

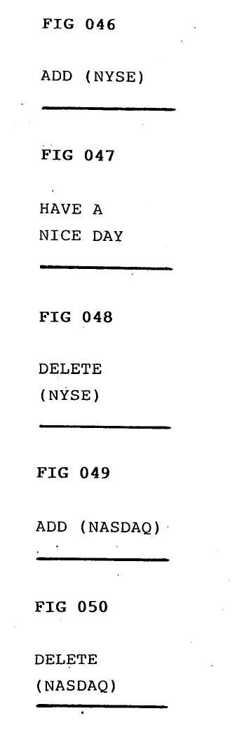

Continuing on, (SEE FIG. 042), then push the PRO key and (SEE FIG. 044). FIG. 044 will be depicted on viewing screen and or window 4G. The “user” of the machine enters in the Four digit PIN #—0000. Then, (SEE FIG. 045). FIG. 045 will be depicted on viewing screen and or window 4G for Three Seconds then (SEE FIG. 046). FIG. 046 will be depicted on viewing screen and or window 4G.

Had the “user” of the machine entered the wrong PIN # (SEE FIG. 044). FIG. 044 would be depicted on viewing screen and or window 4G until such time as when either the right Four digit PIN # is entered in and or the machine is shut off and or powered down.

The “user” of the machine did enter the proper pin # therefore and or at this point the machine's viewing screen and or window still depicts (SEE FIG. 046). The machine is armed and ready for Trading, the machine is on and or running. Push the OFF key and (SEE FIG. 047). FIG. 047 will be depicted on viewing screen and or window 4G for Three Seconds then the machine shut off and or powers down.

Push the ON key then (SEE FIG. 039). FIG. 039 will be depicted on viewing screen and or window 4G for Three Seconds then (SEE FIG. 040). FIG. 040 will be depicted on the machine's viewing screen and or window 4G for Three Seconds then (SEE FIG. 041). FIG. 041 will be depicted on the machine's viewing screen and or window 4G for Three Seconds then (SEE FIG. 043-A). FIG. 043-A will be depicted on the machine's viewing screen and or window 4G. Push the PRO key then (SEE FIG. 044). FIG. 044 will be depicted on the machine's viewing screen and or window 4G.

Note, the machine 1 and or the machine comes equipped with a PIN #, safety feature. Each machine has been assigned an official PIN #, without this PIN #, access to the machine's portfolio feature will be denied. For instructional and or demonstration purposes 0000 will represent the “user” of the machine's demonstration PIN #.

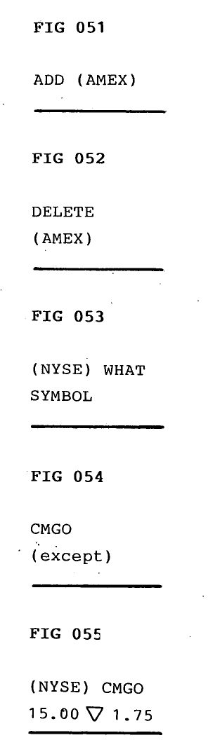

To add a stock symbol into the “user” of the machine's portfolio feature (SEE FIG. 044 reiterated). FIG. 044 is still being depicted on the machine's viewing screen and or window 4G. (Instructional command) and or Type in Four digit PIN # and or code. The “user” of the machine types—0000, (SEE FIG. 045). FIG. 045 will be depicted on the machine's viewing screen and or window 4G for Three Seconds then (SEE FIG. 046). FIG. 046 will be depicted on the machine's viewing screen and or window 4G. Push the NO key then (SEE FIG. 048). FIG. 048 will be depicted on the machine's viewing screen and or window 4G. Push the NO key then (SEE FIG. 049). FIG. 049 will be depicted on the machine's viewing screen and or window 4G. Push the NO key then (SEE FIG. 050). FIG. 050 will be depicted on the machine's viewing screen and or window 4G. Push the NO key then (SEE FIG. 051). FIG. 051 will be depicted on the machine's viewing screen and or window 4G. Push the NO key then (SEE FIG. 052). FIG. 052 will be depicted on the machine's viewing screen and or window 4G. Push the NO key then (SEE FIG. 046 reiterated). FIG. 046 will be depicted on the machine's viewing screen and or window 4G.

At this point in the programming the “user” of the machine has seen the options the machine has to offer. The machine is now back to the First position and or option. For demonstration purposes the “user” of the machine has decided to program a NYSE and or a New York Stock Exchange listed stock symbol therefore—(note, the machine's viewing screen and or window 4G is still depicting FIG. 046), push the YES key then (SEE FIG. 053). FIG. 053 will be depicted on the machine's viewing screen and or window 4G. By utilizing the Keyboard keys the “user” of the machine types in the desired NYSE listed stock symbol. As the “user” of the machine types the stock symbol will be depicted on the machine's viewing screen and or window 4G in the following manner and or fashion, (SEE FIG. 054). FIG. 054 will be depicted on the machine's viewing screen and or window 4G. (note, along with the “user” of the machine's stock symbol CMGO is the word (except) depicted in parenthesis, if the stock symbol is correct the “user” of the machine would push the YES key then (SEE FIG. 055). FIG. 055 will be depicted on the machine's viewing screen and or window 4G.

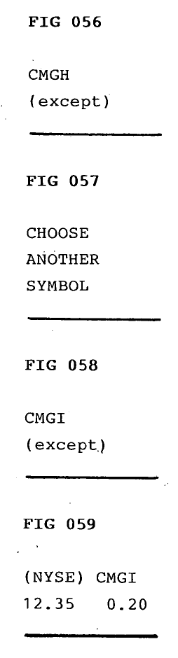

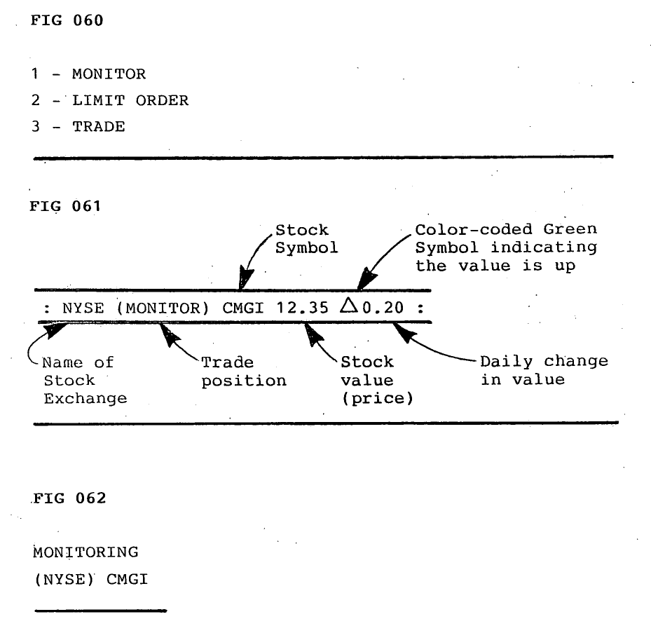

Incorrect symbols—If the stock symbol is incorrect then (SEE FIG. 053 reiterated). FIG. 053 will be depicted on the machine's viewing screen and or window 4G. The “user” of the machine types in—CMGH, (SEE FIG. 056). FIG. 056 will be depicted on the machine's viewing screen and or window 4G. Push the YES key then (SEE FIG. 057). FIG. 057 will be depicted on the machine's viewing screen and or window 4G. Depicted is a NO SUCH SYMBOL EXIST, reply, meaning try another symbol. The “user” of the machine tries for a Third time. The “user” of the machine types—CMGI, (SEE FIG. 058). FIG. 058 will be depicted on the machine's viewing screen and or window 4G. Push the YES key then (SEE FIG. 059). FIG. 059 will be depicted on the machine's viewing screen and or window 4G for Three Seconds then (SEE FIG. 060). FIG. 060 will be depicted on the machine's viewing screen and or window 4G.

At this point the “user” of the machine has Three options, The First of Three options is for the “user” of the machine to Monitor the NYSE listed stock symbol CMGI. This means that Once initiated this NYSE listed stock symbol (CMGI) will begin to scroll from Right to Left on the machine's viewing screen and or window 3F embedded within either a SMTTFD type 4 and or a SMTTFD type 5 depending upon the time of day. A SMTTFD type 4 and a SMTTFD type 5 both contain the same display records, the One and only difference between the Two types of SMTTFD is that a SMTTFD type 4 is a Live, real time SMTTFD whereas a SMTTFD type 5 is a dormant, after Market Hours, Closing Bell prices reiterated SMTTFD. For an illustration of a SMTTFD type 4 and or a SMTTFD type 5, (SEE FIG. 061). The Background of this SMTTFD type 4 and or SMTTFD type 5 is depicted in the color of White. The color-coded symbols, letters and numbers are currently depicted and or illustrated in the color of Green, thus indicating that the depicted stock symbol (CMGI) is up in overall monetary value and or price.

During Market Hours and or from a.m. 9:30 Opening Bell through and or until Closing Bell and or p.m. 4:00 est. time, every time the machine's viewing screen and or window 3F depicts this or any other given stock symbol, the stocks overall value and or price along with the stock symbols daily change in the per share price and yes even the color-coded symbols, letters and numbers will be updated to reflect the current and or Live, real time values and or prices.

During after Market Hours and or from Closing Bell and or p.m. 4:00 est. time through and or until Opening Bell and or a.m. 9:30 est. time, including Twenty Four hours of the day and or night on any and or all weekends and Federal Holidays, every time the machine's viewing screen and or window 3F's SMTTFD type 5's rotation order depicts this or any other given stock symbol, the stocks Closing Bell value and or per share price along with the stocks Closing Bell posted, daily change in the per share price and yes even the color-coded symbols, letters and numbers will be reiterated throughout the after Market Hours session until such time as when the Markets open for the business of Trading shares of listed company s stock, once again.

A SMTTFD type 4 and or a SMTTFD type 5 can and will depict any and or all exchange listed stock symbols programmed within the monitor position for a duration equivalent to One point Five Seconds per symbol and or display.

Limit Order Stock Trades—The Second of Three options is for the “user” of the machine to set a Limit-Order Stock Trade. An example of a Limit-Order Stock Trade is—the NYSE's exchange listed stock symbol (CMGI) is currently trading at Twelve dollars and Thirty Five cents and for example purposes this particular stock is currently up Twenty cents since the Opening Bell was sounded. The “user” of the machine believes that the per share price of the said mentioned stock CMGI will come down in value and or price. The “user” of the machine has concluded that a good price to pay for and or buy the said mentioned stock shares should be Eleven dollars per share. The “user” of the machine has also concluded that in time this said mentioned stock will not only regain it's previous value and or price but will eventually grow and or comeback even stronger then previously traded for therefore the “user” of the machine set a sell Limit-Order Stock Trade at the price the “user” of the machine estimates that the shares of this particular company's stock will and or could eventually trade for and or at. For example purposes the “user” of the machine sets the sell Limit-Order Stock Trade at Eighteen dollars per share. Once the “user” of the machine initiates the Limit-Order Stock Trade the said mentioned trade is held in limbo within the Machine 1 and or the machine's digital notebook and or within the machine's customized, personal portfolio feature. The Nyse exchange listed stock symbol CMGI is set, the machine will automatically buy CMGI stock shares if and when the stocks value decreases to the “user” of the machine's estimated Eleven dollars per share value and or price, then and only then will the machine signal the Machine 1 Dissemination Center's Mainframe Computer Server's search engine to purchase the said mentioned shares of stock via wireless digital radio transmissions. The Machine 1 Dissemination Center's Mainframe Computer Server's search engine receives the wireless digital radio trade instructions then implements a machine assisted stock trade via Fiber Optic hard and or land lines to a Second Mainframe Computer Server housed and maintained at and by a contracted Federally licensed and insured, International Brokerage House. The Broker then deducts the purchase price of Eleven dollars per'share of stock ordered along with a small fee for services rendered.(approximately from Five to Twenty dollars per transaction) from the “user” of the machine's portfolio/Money Market Fund accounts. Once the Broker deducts the appropriate sums of money, then and only then will the Broker place the stock trade, X ammount of shares with the NYSE, buy CMGI @ Eleven dollars per share. These said mentioned stock shares are kept and maintained within the “user” of the machine's Personal Portfolio/Money Market Fund accounts housed and or stored at and or within the contracted Brokerage House. The “user” of the machine nows owns these said mentioned machine purchased, NYSE listed, CMGI Stock Shares.

Now and only now will the machine activate the sell, Limit Order stock trade. With a sell, Limit Order stock trade poised and or set to sell the previously obtained and or machine purchased, NYSE listed, CMGI stock shares, the “user” of the machine sits back and patiently waits. If and when the stocks value and or per share price reaches the said mentioned and or previously programmed estimation of Eighteen dollars per share price then and only then will the Machine 1 and or the machine signal (via wireless digital radio transmissions) the Machine 1 Dissemination Center's Mainframe Computer systems. The Machine 1 Dissemination Center then immediately signals (via Fiber Optic hard and or land lines) the contracted Brokerage House's Mainframe Computer Server's search engine a command instruction to Trade and or sell the said mentioned, NYSE listed, CMGI stock shares at Eighteen dollars per share. The Brokerage House and or the Broker then sells the NYSE listed, CMGI stock shares for the Trading price of Eighteen dollars per share. The Broker then deducts a small fee once again (from Five to Twenty dolars) for services rendered. The Broker then deposits the remainder of funds into the “user” of the machine's adjoining Money Market accounts. The “user” of the machine just made a profit of Seven dollars per share of NYSE listed CMGI stock without having to physically and or mentally keep track of and or monitor the Market's daily activity. The “user” of the machine simply pushes a few buttons and then just waits for the profits and or the ships to come in.

The Third of Three options is for the “user” of the machine to directly Trade, buy and or sell, shares of stocks at the current, Live value and or per share price. During Market Hours and or from a.m. 9:30 est. through and or until p.m. 4:00 est. time, the Trades are executed and or traded immediately upon receipt at the Machine 1 Dissemination Center's Computer generated and or virtual Trading Platform. During after Market Hours the Trade will sit in limbo within the machine's customized, personal portfolio feature and or digital notebook until such time as a.m. 9:30 est. time, Opening Bell. Once the Opening Bell sounds the machine automatically signal the Machine 1 Dissemination Center's Mainframe's computer generated Trading Platform instructing the search engine to place the stock trade with the contracted Brokerage House. The Brokerage House's Mainframe Computer Server's search engine then deducts for a buy trade and or adds for a sell trade to and or from the “user” of the machine's personal portfolio/Money Market Fund accounts. Once all fiduciary obligations are met, then and only then will the Broker make the stock trade.

Once the Brokerage House and or the Broker completes the said mentioned transaction and or stock trade, the Brokerage House's Mainframe Computer Network Server's search engine signals the Machine 1 Dissemination Center's Mainframe computer servers (via Fiber Optic hard and or land lines) of the completed transaction and or stock trade. The Dissemination Center automatically records and stores this information and or economic data within the Center's Mainframe Computer Database and or File Server, under and or within the “user” of the machine's Portfolio Transaction Review Account. Once the economic data is recorded and or stored within the Center's Database servers, the Center's Network Server's search engine will signal (via wireless digital radio transmissions) the Machine 1 and or the machine notice of the said mentioned, completed transaction and or stock trade. The Machine records and stores this information and or economic data within a digital notebook and or within the machine's portfolio transaction review feature, (SEE Mode 2/modes of operation). Once the, information and or economic data is recorded and or stored within the machine's portfolio transaction review feature the data will automatically be depicted for monitoring and or tracking purposes on the machine's viewing screen and or window 3F embedded, within either a SMTTFD type 4 and or a SMTTFD type 5. This concludes the Trading options of the machine's customized personal portfolio feature.

The “user” of the machine has opted for the First choice and or the First of Three options and or to Monitor the NYSE exchange listed stock symbol CMGI. For demonstration and or for instructional aid purposes (SEE FIG. 060, reiterated). FIG. 060 is still being depicted on the machine's viewing screen and or window 4G. Push the (W1) key then (SEE FIG. 062). FIG. 062 will be depicted on the machine's viewing screen and or window 4G for Three Seconds then (SEE FIG. 057). FIG. 057 will be depicted on the machine's viewing screen and or window 4G. Note, the NYSE exchange listed stock symbol CMGI is now scrolling in the Monitor position, formatted and or embedded within a SMTTFD on the machine's viewing screen and or window 3F, for an illustration (SEE FIG. 063). At this point the “user” of the machine has Two choices, the First choice is to end programming, the Second choice is to choose another symbol. The “user” of the machine has opted for the First of Two choices and or to end programming therefore—Push the NO key then (SEE FIG. 047). FIG. 047 will be depicted on the machine's viewing screen 4G for Three Seconds then screen 4G will shut off and or power down. Meanwhile, live data is still scrolling and rotating on viewing screen and or windows 1A/1B, 2C/2D and 3E/3F. Push the OFF key then Machine 1 and or the machine shuts off and or powers down.

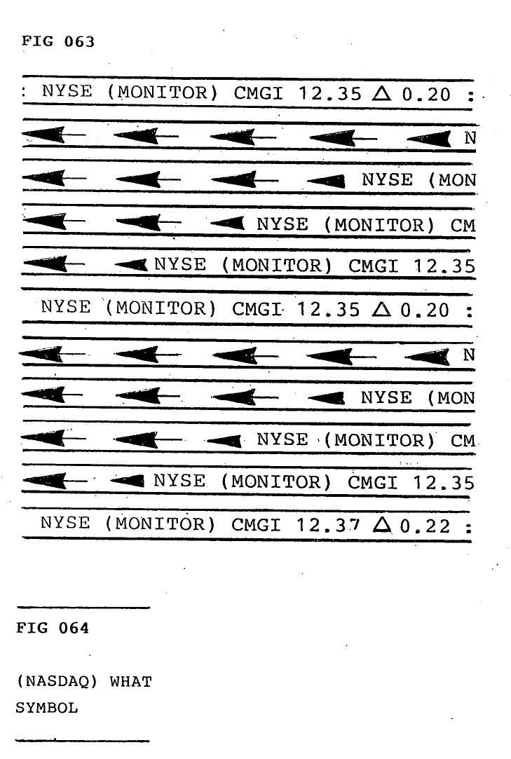

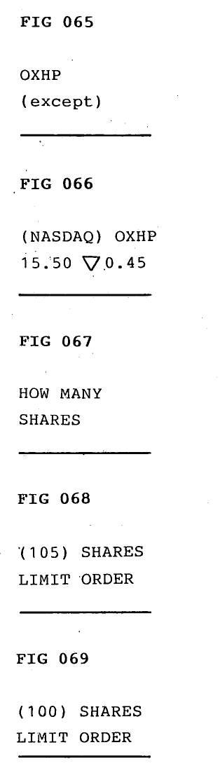

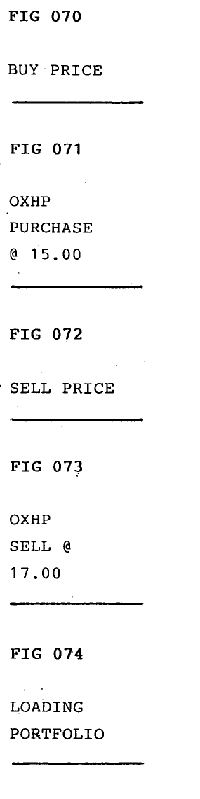

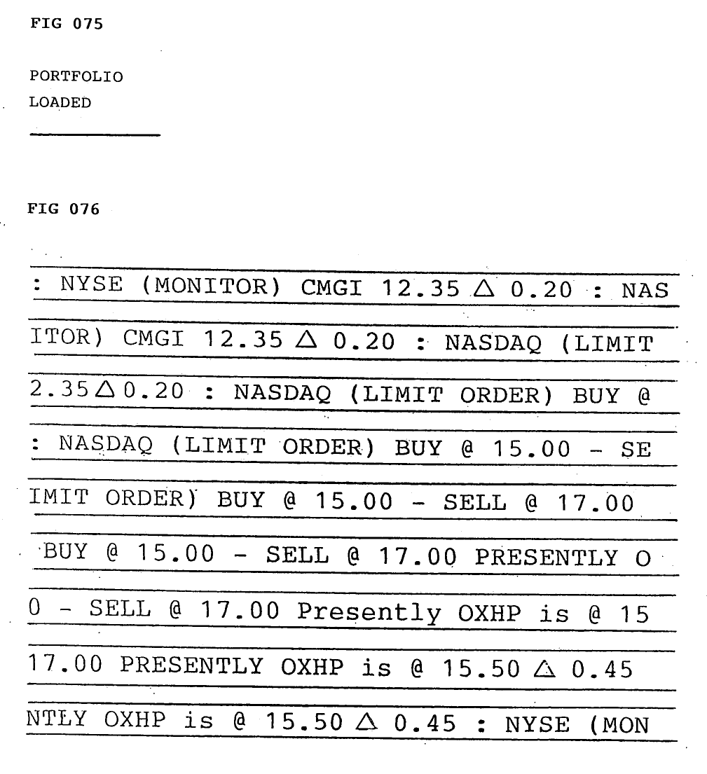

The Second of Two choices and or choice Two, (SEE FIG. 057, reiterated). FIG. 057 is still being depicted on the machine's viewing screen and or window 4G. Push the YES key then (SEE FIG. 046). FIG. 046 will be depicted on the machine's viewing screen 4G. Push the NO key then (SEE FIG. 048). FIG. 048 will be depicted on the machine's viewing screen 4G. Push the NO key then (SEE FIG. 049). FIG. 049 will be depicted on the machine's viewing screen and or window 4G. Note, the “user” of the machine would like to program a NASDAQ exchange listed stock symbol into the portfolio therefore—Push the YES key then (SEE FIG. 064). FIG. 064 will be depicted on the machine's viewing screen and or window 4G. COMMAND INSTRUCTION—the “user” of the machine types in the desired stock symbol, the “user” of the machine typed—OXHP, (SEE FIG. 065). FIG. 065 will be depicted on the machine's viewing screen and or window 4G. Note, this is the NASDAQ exchange listed stock symbol that the “user” of the machine chooses therefore—Push the YES key then (SEE FIG. 066). FIG. 066 will be depicted on the machine's viewing screen and or window 4G for Three Seconds then (SEE FIG. 060). FIG. 060 will be depicted on the machine's viewing screen and or window 4G. Note, the Customized, personal portfolio feature is presently and or still Monitoring the NYSE exchange listed stock symbol CMGI, (SEE FIG. 062). The “user of the machine is ready to load a Second stock symbol into the customized, personal portfolio feature. The “user” of the machine chooses to set a Limit Oreder Stock Trade with the NASDAQ exchange listed stock symbol OXHP therefore, (SEE FIG. 060), then Push the (E2) key then (SEE FIG. 067). FIG. 067 will be depicted on viewing screen and or window 4G. COMMAND INSTRUCTION—the “user” of the machine types in the quantity of stock shares and or the number 105, (SEE FIG. 068). FIG. 068 will be depicted on the machine's viewing screen and or window 4G. Note, if this quantity and or number of NASDAQ exchange listed stock shares, (SEE FIG. 068), was correct the “user” of the machine would now push the YES key. The “user” of the machine only wanted One Hundred shares therefore the “user” of the machine pushes the NO key then (SEE FIG. 067, reiterated). FIG. 067 will be depicted on the machine's viewing screen and or window 4G. COMMAND INSTRUCTION—the “user” of the machine types in the desired quantity and or One Hundred, (SEE FIG. 069). FIG. 069 will be depicted on the machine's viewing screen and or window 4G. Push the YES key then (SEE FIG. 070). FIG. 070 will be depicted on the machine's viewing screen and or window 4G. COMMAND INSTRUCTION—the “user” of the machine types in the monatary figure and or Fifteen dollars, (SEE FIG. 071). FIG. 071, will be depicted on the machine's viewing screen and or window 4G. Push the YES key then (SEE FIG. 072). FIG. 072 will be depicted on the machine's viewing screen and or window 4G. COMMAND INSTRUCTION—the “user” of the machine types in Seventeen dollars, (SEE FIG. 073). FIG. 073 will be depicted on the machine's viewing screen and or window 4G. Push the YES key then (SEE FIG. 074). FIG. 074 will be depicted on the machine's viewing screen and or window 4G for three Seconds then (SEE FIG. 075). FIG. 075 will be depicted on the machine's viewing screen and or window 4G for Three Seconds then (SEE FIG. 057). FIG. 057 will be depicted on the machine's viewing screen and or window 4G. Note, the NASDAQ exchange listed stock symbol OXHP is now scrolling along directly proceeding the NYSE exchange listed stock symbol CMGI, (SEE FIG. 076).

The machine 1 and or the machine's customized, personal portfolio feature has a capacity to list the stock symbols of and or from as few as One and or up to Six Hundred exchange listed companies. The portfolio listings and or the stock exchange sequence will be as follows, First all NYSE exchange listed stock symbols are depicted in an Alphabetical Order sequence. Second, all NASDAQ exchange listed stock symbols are depicted in an Alphabetical order sequence directly following the last NYSE exchange listed stock symbol. Third, all AMEX exchange listed stock symbols are depicted in an Alphabetical Order sequence directly following the last NASDAQ exchange listed stock symbol. Note, if their are no NASDAQ exchange listed stock symbols then the AMEX exchange listed stock symbols will directly follow the last NYSE exchange listed stock symbol. These said mentioned stock exchanges are depicted in succession embedded within the same and or One long string of characters for viewing and or display on the machine's viewing screen and or window 3F.

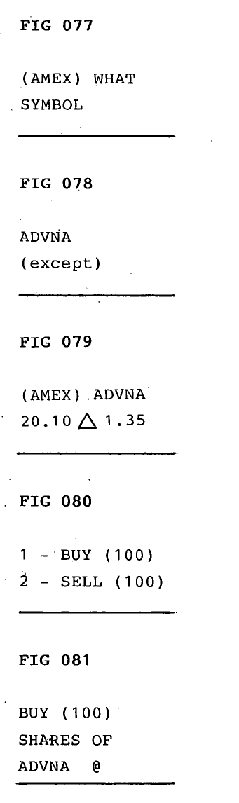

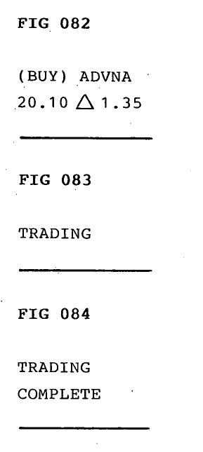

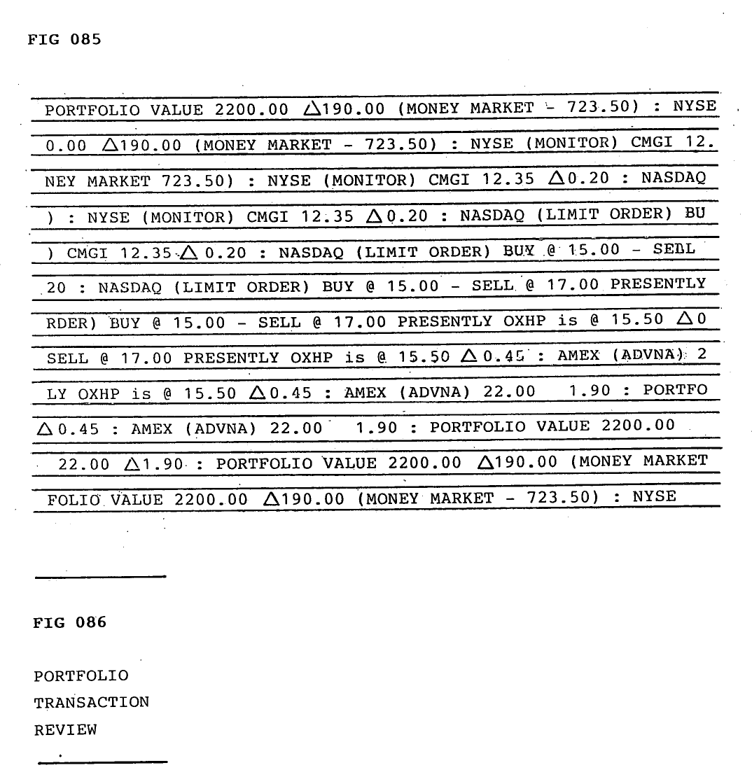

The “user” of the machine has decided to choose another symbol therefore, (SEE FIG. 057, reiterated). FIG. 057 is still being depicted on the machine's viewing screen and or window 4G. Push the YES key then (SEE FIG. 046). FIG. 046 will be depicted on the machine's viewing screen and or window 4G. Note, the “user” of the machine has decided to purchase and or add an AMEX exchange listed stock symbol to the portfolio therefore—Push the NO key then (SEE FIG. 048). FIG. 048 will be depicted on the machine's viewing screen and or window 4G. Push the NO key then (SEE FIG. 049). FIG. 049 will be depicted on the machine's viewing screen and or window 4G. Push the NO key then (SEE FIG. 050). FIG. 050 will be depicted on the machine's viewing screen and or window 4G. Push the NO key then (SEE FIG. 051). FIG. 051 will be depicted on the machine's viewing screen and or window 4G. Push the YES key then (SEE FIG. 077). FIG. 077 will be depicted on the machine's viewing screen and or window 4G. COMMAND INSTRUCTION—the “user” of the machine types the stock symbol ADVNA, (SEE FIG. 078). This is the symbol that the “user” of the machine wanted therefore Push the YES key then (SEE FIG. 079). FIG. 079 will be depicted on the machine's viewing screen and or window 4G for Three Seconds then (SEE FIG. 060). FIG. 060 will be depicted on the .machine's viewing screen and or window 4G. The “user” of the machine has chosen to Trade and or buy this AMEX exchange listed stock symbol ADVNA therefore—Push the (R3) key then (SEE FIG. 067). FIG. 067 will be depicted on the machine's viewing screen and or window 4G. COMMAND INSTRUCTION—the “user” of the machine types in One Hundred, (SEE FIG. 080). FIG. 080 will be depicted on the machine's viewing screen and or window 4G. Push the (W1) key then (SEE FIG. 081). FIG. 081 will be depicted on the machine's viewing screen and or window 4G for Three Seconds then (SEE FIG. 082). FIG. 082 will be depicted on the machine's viewing screen and or window 4G. Push the YES key then (SEE FIG. 083). FIG. 083 will be depicted on the machine's viewing screen and or window 4G for Three Seconds then then (SEE FIG. 084). FIG. 084 will be depicted on the machine's viewing screen and or window 4G for Three Seconds then (SEE FIG. 057). FIG. 057 will be depicted on the machine's viewing screen and or window 4G. Push the YES key then,(SEE FIG. 046, reiterated). FIG. 046 will be depicted on the machine's viewing screen and or window 4G. The “user” of the machine does not wish to Choose Another Symbol therefore when the machine's viewing screen and or window 4G depicts (SEE FIG. 057), Push the NO key then (SEE FIG. 084). FIG. 084 will be depicted on the machine's viewing screen and or window 4G for Three Seconds then (SEE FIG. 047). FIG. 047 will be depicted on the machine's viewing screen and or window 4G for Three Seconds then screen and or window 4G will shut off and or power down. Note, the “user” of the machine just purchased One Hundred shares of ADVNA from and or with the AMEX and or the American Stock Exchange. For an illustration of the portfolio content and or data (SEE FIG. 085).

Whenever the “user” of the machine sees and or the machine's viewing screen and or window 4G depicts the phrase Add (NYSE), (SEE FIG. 046), the “user” of the machine will have Three options. The First of Three options would be for the “user” of the machine to add NYSE Stock Symbols (meaning, to aquire more) and or to set limit Orders and or to Trade and or to monitor shares of NYSE echange listed stock symbols. The Second of Three options would be for the “user” of the machine to peruse the other and or alternative choices within Mode 1, Modes of operation. The Third of Three options enables the “user” of the machine to change the machine's normal Mode of operation and or Mode 1 to any One of Four uniquely different Modes of operation. As said mentioned the First of Four Modes of operation and or Mode 1 is automatically programmed into the machine as the normal and or primary Mode of operation.

This means that during Market Hours and or from Opening Bell and or a.m. 9:30 est. time, Monday through Friday except for Federal Holidays, all Three U.S. Stock Exchanges will be depicted Live, embedded within real time, SMTTFD type 1. On the machine's viewing screen and or window 2C the NYSE will be depicted Live, embedded within a real time, SMTTFD type 1. On the machine's viewing screen and or window 2D the NASDAQ will be depicted Live, embedded within a real time, SMTTFD type 1. On the machine's viewing screen and or window 3E the AMEX will be depicted Live, embedded within a real time, SMTTFD type 1. This said mentioned SMTTFD type 1 is the normal and or primary Mode of operation and or Mode 1.

The Second of Four Modes of operation and or the “user” of the machine's customized, personal portfolio transaction review feature and or the portfolio transaction review mode of operation and or Mode 2. Note, Viewing screen and or window 1A and or MCTSFD types One through Four will not be affected by the Modes of operation feature therefore viewing screen and or window 1A will not be altered in any way and or form. As for the data being depicted on the machine's viewing screen and or window 1B and or MCTSFD type Five will not be affected nor will it be altered in any way and or form. As for the data being depicted on the machine's viewing screen and or windows 2C/2D and 3E embedded within either a SMTTFD type 1, type 2, type 3 and or type 6 will not be affected nor will it be altered in any way and or form. As for the data being depicted on the machine's viewing screen and or window 3F embedded within either a SMTTFD type 4, type 5 and or type 6 will not be affected nor will it be altered in any way and or form. As for the data being depicted on the machine's viewing, screen and or window 4G and or the “user” of the machine's interface with the machine and or the instructional aid will be affected and or altered in a signifficant way. Viewing screen and or window 4G's usual depiction of an instructional and or Trading aid is replaced with a digital notebook entitled the Portfolio Transaction Review. When the machine's viewing screen and or window 4G is depicting the “user” of the machine's customized, personal portfolio, transaction review feature, then and only then will the machine be operating within the Portfolio Transaction Review mode of operation and or Mode Two of Four Modes of operation.

The Third of Four modes of operation is the machine 1 and or the machine's Market Shift feature and or the Market Shift mode of operation and or Mode Three of Four Modes of operation. When the machine is in the normal mode of operation and or Mode One the SMTTFD depicted on the machine's viewing screen and or windows 2C/2D and 3E will either be a SMTTFD type 1, type 3 and or type 6. When the machine is in the Market Shift position and or mode of operation and or Mode 3 the SMTTFD type 1, type 3 and or type 6 will be replaced by and or with a SMTTFD type 2, type 3 and or type 6. The SMTTFD type 2 that replaces the SMTTFD type 1 and visa versa is the Market Shift feature and or the Market Shift Mode of operation and or Mode 3.

The Fourth of Four modes of operation and or Mode 4 is the machine's language capabilities feature and or the language capabilities mode of operation and or Mode 4. When the machine is in mode 4 the economic data being depicted on viewing screen and or windows 1A/1B, 2C/2D and 3E/3F will not be affected nor altered in any way and or form. When the machine is in Mode 4 the instructional guide and or Trading aid usually depicted on the machine's viewing screen and or window 4G will be replaced with the language capabilities feature and and or option which enables the “user” of the machine the means and ability to activate the tri-lingual function and or feature. This said mentioned tri-lingual feature and or Mode 4 enables the “user” of the machine the ability to translate the operating instructions and or the Trading aid from English into either French and or Spanish. This language capabilities feature and or the language capabilities mode of operation is Mode 4 of Four Modes of operation.

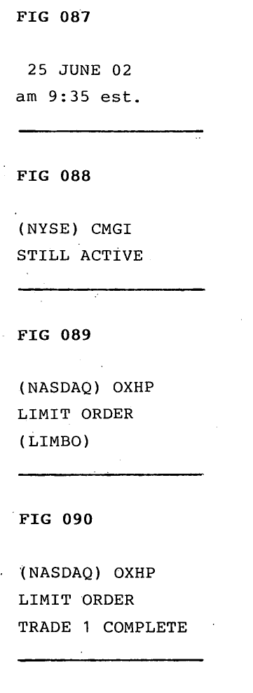

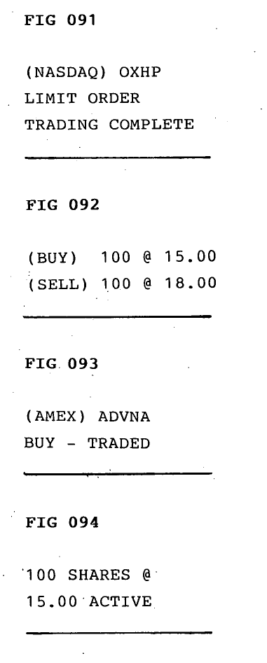

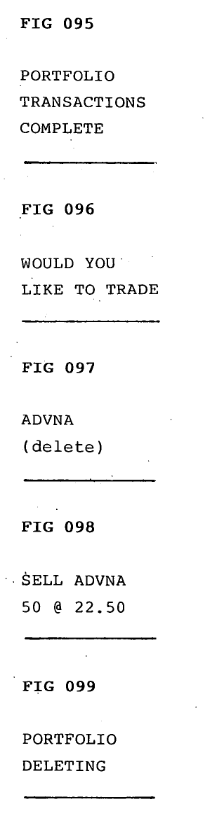

Push the ON key then (SEE FIG. 039). FIG. 039 will be depicted on the machine's viewing screen and or window 4G for Three Seconds then (SEE FIG. 040). FIG. 040 will be depicted on the machine's viewing screen and or window 4G for Three Seconds then (SEE FIG. 041). FIG. 041 will be depicted on the machine's viewing screen and or window 4G for Three Seconds then (SEE FIG. 043-B). FIG. 043-B will be depicted on the machine's viewing screen 4G. Push the PRO key then (SEE FIG. 044). FIG. 044 will be depicted on the machine's viewing sceen and or window 4G. COMMAND INSTRUCTION—the “user” of the machine enters and or types in the Four digit PIN #0000, then (SEE FIG. 045). FIG. 045 will be depicted on the machine's viewing screen and or window 4G for Three Seconds then (SEE FIG. 046). FIG. 046 will be depicted on the machine's viewing screen and or window 4G. Note, when this command instruction is given and or depicted, the machine's mode of operation is in position for mode shift and or Market Shift. So far the “user” of the machine has programmed Three transactions within the “user” of the machine's portfolio feature. For demonstration purposes the “user” of the machine would like to review these transactions and or Stock Trades therefore, (SEE FIG. 046). FIG. 046 is still being depicted on the machine's viewing screen and or window 4G. Push the MODE key then (SEE FIG. 086). FIG. 086 will be depicted on the machine's viewing screen and or window 4G. Push the NO key then (SEE FIG. 046, reiterated) or Push the YES key then (SEE FIG. 074). FIG. 074 will be depicted on the machine's viewing screen and or window 4G for Three Seconds then (SEE FIG. 086). FIG. 086 will be depicted on the machine's viewing screen and or window 4G for Three Seconds then (SEE FIG. 062). FIG. 062 will be depicted on the machine's viewing screen and or window 4G for Three Seconds then (SEE FIG. 088). FIG. 088 will be depicted on the machine's viewing screen and or window 4G for Three Seconds then (SEE FIG. 087). FIG. 087 will be depicted on the machine's viewing screen 4G for Three Seconds then (SEE FIG. 089). FIG. 089 will be depicted on the machine's viewing screen 4G for Three Seconds then (SEE FIG. 090). Note, the depiction of the word LIMBO in (SEE FIG. 089), means and or indicates to the “user” of the machine that the Transaction and or the Trade has not yet been executed and or Traded. When this Trade has been officially Traded then the depicted word LIMBO will be replaced with (SEE FIG. 090). FIG. 090 will be depicted on the machine's viewing screen and or window 4G. Note, a Limit Order stock trade has Two individual Trades connected to it, a BUY Trade and a SELL Trade. When the Third line of (SEE FIG. 090) depicts TRADE 1 COMPLETE this means and or indicates to the “user” of the machine that the BUY Trade has been executed and or Traded. Now, the SELL Trade is active and or poised for Trading. When the “user” of the machine sees the Third line of (SEE FIG. 091), this means and or indicates that the Second part of this Two part Trade has been executed and or Traded. FIG. 091 will be depicted on the machine's viewing screen and or window 4G. Note, to return to the Portfolio Transaction Review (SEE FIG. 089, reiterated). FIG. 089 will be depicted on the machine's viewing screen and or window 4G for Three Seconds then (SEE FIG. 092). FIG. 092 will be depicted on the machine's viewing screen 4G for Three Seconds then (SEE FIG. 087). FIG. 087 will be depicted on the machine's viewing screen 4G for Three Seconds then (SEE FIG. 093). FIG. 093 will be depicted on the machine's viewing screen 4G for Three Seconds then (SEE FIG. 094). FIG. 094 will be depicted on the machine's viewing screen and or window 4G for Three Seconds then (SEE FIG. 095). FIG. 095 will be depicted on the machine's viewing screen 4G for Three Seconds then (SEE FIG. 096). FIG. 096 will be depicted on the machine's viewing screen and or window 4G. Push the NO key then (SEE FIG. 047). FIG. 047 will be depicted on the machine's viewing screen and or window 4G for Three Seconds then viewing screen and or window 4G shuts off and or powers down. Note, had the “user” of the machine wanted to make a Trade (SEE FIG. 096, reiterated). FIG. 096 is the depiction on the machine's viewing screen and or window 4G. Push the YES key then (SEE FIG. 046). FIG. 046 will be depicted on the machine's viewing screen and or window 4G.

FIG. 046 is still being depicted on the machine's viewing screen and or window 4G. For demonstration purposes the “user” of the machine would like to Trade and or sell fifty of the One Hundred AMEX exchange listed company ADVNA's stock shares. These said mentioned ADVNA stock shares were purchased via the machine earlier in the demonstration and are therefore already programmed within the portfolio feature therefore—Push the NO key then (SEE FIG. 048). FIG. 048 will be depicted on the machine's viewing screen 4G. Push the NO key then (SEE FIG. 049). FIG. 049 will be depicted on the machine's viewing screen 4G. Push the NO key then (SEE FIG. 050). FIG. 050 will be depicted on the machine's viewing screen and or window 4G. Push the NO key then (SEE FIG. 051). FIG. 051 will be depicted on the machine's viewing screen and or window 4G. Push the NO key then (SEE FIG. 052). FIG. 052 will be depicted on the machine's viewing screen and or window 4G. Note, for demonstration purposes the “user” of the machine desires to delete, trade and or sell Fifty shares of an AMEX exchange listed company and or ADVNA, therefore—Push the YES key then (SEE FIG. 077). FIG. 077 will be depicted on the machine's viewing screen and or window 4G. The “user” of the machine desires to Trade shares of stock at and or with the AMEX and or the American Stock Exchange therefore the “user” of the machine types in the stock symbol of the AMEX exchange listed company, the “user” of the machine types, ADVNA then (SEE FIG. 097). FIG. 097 will be depicted on the machine's viewing screen and or window 4G. Push the NO key then (SEE FIG. 077, reiterated) or Push the YES key then (SEE FIG. 067). FIG. 067 will be depicted on the machine's viewing screen and or window 4G. The “user” of the machine would like to Trade and or sell half of the One Hundred shares and or Fifty shares of ADVNA therefore, the “user” of the machine types in, 50 then (SEE FIG. 098). FIG. 098 will be depicted on the machine's viewing screen and or window 4G. Push the NO key then (SEE FIG. 067, reiterated) or Push the YES key then (SEE FIG. 099). FIG. 099 will be depicted on the machine's viewing screen and or window 4G for Three Seconds then (SEE FIG. 057). Note, the machine 1 and or the machine signals the Machine 1 Dissemination Center, the Center signals and or sends the Trade to the Broker, the Broker makes the Trade then signals the Center, the Center signals the Machine 1 and or the machine of the completed transaction and or stock trade. (SEE FIG. 099) then (SEE FIG. 057). FIG. 057 will be depicted on the machine's viewing screen and or window 4G. Push the YES key then (SEE FIG. 046, reiterated) or Push the NO key then (SEE FIG. 047). FIG. 047 will be depicted on the machine's viewing screen and or window 4G for Three Seconds then viewing screen and or window 4G shuts off and or powers down.

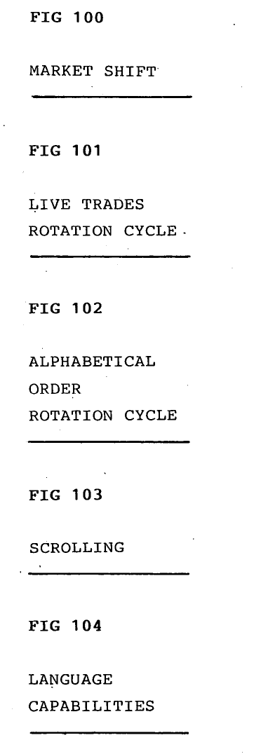

Push the ON key then (SEE FIG. 039). FIG. 039 will be depicted on the machine's viewing screen and or window 4G for Three Seconds then (SEE FIG. 040). FIG. 040 will be depicted on the machine's viewing screen and or window 4G for Three Seconds then (SEE FIG. 041). FIG. 041 will be depicted on the machine's viewing screen and or window 4G for Three Seconds then (SEE FIG. 043-A). FIG. 043-A will be depicted on the machine's viewing screen and or window 4G. Push the PRO key then (SEE FIG. 044). FIG. 044 will be depicted on the machine's viewing screen and or window 4G. COMMAND INSTRUCTION, the “user” of the machine enters and or types in the Four digit PIN #0000 then (SEE FIG. 045). FIG. 045 will be depicted on the machine's viewing screen and or window 4G for Three Seconds then (SEE FIG. 046). FIG. 046 will be depicted on the machine's viewing screen and or window 4G. Push the MODE key then (SEE FIG. 086, reiterated). FIG. 086 will be depicted on the machine's viewing screen and or window 4G. Push the MODE key then (SEE FIG. 100). FIG. 100 will be depicted on the machine's viewing screen and or window 4G. Push the YES key then (SEE FIG. 101) FIG. 101 will be depicted on the machine's viewing screen and or window 4G. Push the NO key then (SEE FIG. 102). FIG. 102 will be depicted on the machine's viewing screen and or window 4G. Push the YES key then (SEE FIG. 103). FIG. 103 will be depicted on the machine's viewing screen and or window 4G for Three Seconds then (SEE FIG. 047). FIG. 047 will be depicted on the machine's viewing screen and or window 4G for Three Seconds then viewing screen and or window 4G shuts off and or powers down. Push the OFF key then the Machine 1 and or the machine shuts off and or powers down.

Market Shift (Overview (Revisited): Begin—

During Market Hours when the Machine 1 and or the machine is in the normal and or primary mode of operation and or Mode 1 of 4, a live, real time SMTTFD type 1 will be depicted on the machine's viewing screen and or windows 2C/2D and 3E. Once the Market Shift feature and or the Market Shift Mode of operation and or Mode 3 has been activated the live, real time SMTTFD type 1 being depicted on the machine's viewing screen and or windows 2C/2D and 3E will be replaced by and or with a live, real time, A through Z, SMTTFD type 2. More, the Machine 1 and or the machine in Mode 1 depicts live, real time, Stock Trades from and or with the NYSE and or the New york Stock Exchange's Trading Floor, formatted and or embedded within a live, real time SMTTFD type 1 on the machine's viewing screen and or window 2C. Even more, once the Market Shift and or Mode 3 has been activated, the Machine 1 in Mode 3 depicts the NYSE and or the New York Stock Exchange's Big Board and or the NYSE Main Table, formatted and or embedded within a live, real time, A through Z, Alphabetical Order, SMTTFD type 2 on the machine's viewing screen and or window 2C.

The NYSE's Big Board of Trades and or the New York Stock Exchange's Main Table—The NYSE's Big Board list approximately Four Thousand One Hundred company's Stock Symbols along with each symbol's current, per share price and the daily change in the per share price. The Machine 1 Dissemination Center's Mainframe Database Server's search engine extracts the Top Six Hundred of the said mentioned companies (according to Market Capitalization). This extracted list of the Top Six Hundred exchange listed stock symbols is numbered and or sequenced One through Six Hundred in a live, A through Z, Alphabetical Order, rotation cycle and or a SMTTFD type 2 for depiction (via wireless, digital radio transmissions) onto the machine's viewing screen and or window 2C. This NYSE SMTTFD type 2 enables the “user” of the machine the ability, the means and the convenience to view, monitor and track the NYSE's Top Six Hundred companies (according to Market Capitalization).

During Market Hours and or from a.m. 9:30 est., through and or until p.m. 4:00 est. time, the economic data and or the Top Six Hundred NYSE exchange listed stock symbols along with the symbol's per share prices and the symbol's daily change in the per share price are formatted and or embedded with color coded symbols; letters and numbers that are continuously updated with current and or live and or real time values and or prices at the end of each Fifteen Minute, Six Hundred Symbols, rotation cycle. More, during after Market Hours and or from p.m. 4:00 est., through and or until Opening Bell and or a.m. 9:30 est. time, the Closing Bell and or the p.m. 4:00 est. time value and or prices posted at the end of the last live Market Session will be reiterated at the end of each Fifteen Minute rotation cycle and or at the end of each SMTTFD type 3 until such time as when the Markets open for the business of Trading shares of listed company's stock, once again.

More, the Machine 1 and or the machine in Mode 1 depicts live, real time Trades from and or with the NASDAQ and or the NASDAQ Stock Exchange's Trading Floor, formatted and or embedded within a SMTTFD type 1 on the machine's viewing screen and or window 2D. Even more, once the Market Shift and or Mode 3 has been activated the machine's viewing screen and or window 2D will begin to depict the NASDAQ Stock Exchange's Big Board of trades and or the NASDAQ's Main table, formatted and or embedded within a SMTTFD type 2. The NASDAQ's Big Board of trades and or the NASDAQ Stock Exchange's Main Table list approximately Three Thousand Six Hundred company's stock symbols along with each symbol's.current per share price and the daily change in the per share price of the depicted symbol. The Machine 1 Dissemination Center .s Mainframe Computer Database server's search engine extracts the Top Six Hundred of the said mentioned stock symbols (according to Market Capital Capitalization). This extracted list of the Top Six Hundred NASDAQ exchange listed stock symbols is numbered and or sequenced One through Six Hundred in a live, A through Z, Alphabetical Order rotation cycle and or a SMTTFD type 2 for depiction (via wireless, digital radio transmissions) onto the machine's viewing'screen and or window 2D. This NASDAQ SMTTFD type 2 enables the “user” of the machine the ability, the means and the convenience to view, monitor and track the NASDAQ's Top Six Hundred companies (according to Market Capitalization) on the machine's viewing screen and or window 2D.

During Market Hours and or from am 9:30 est., through and or until p.m. 4:00 est. time, the economic data and or the said mentioned Six Hundred NASDAQ exchange listed stock symbols along with the symbol's per share price and the symbol's daily change in per share prices, formatted and or embedded with color-coded symbols, letters and numbers will be updated with current and or live and or real time values and or prices once every Fifteen Minutes and or at the end of each Fifteen Minute rotation cycle. During after Market Hours and or from p.m. 4:00 est., through and or until Opening Bell and or a.m. 9:30 est. time, the p.m. 4:00 est. time,. Closing Bell color-coded values and or prices will be reiterated at the end of each Fifteen Minute rotation cycle and or at the end of each SMTTFD type 3 until such time as when the Markets open for the business of trading shares of listed company's stock, once again.

More, the machine 1 and or the machine in Mode 1 depicts live, real time stock trades form and or with the AMEX and or the American Stock Exchange's Trading Floor depicted formatted and or embedded within a SMTTFD type 1 on the machine's viewing screen and or window 3E. Even more, once the Market Shift feature and or Mode 3 has been activated the machine's viewing screen and or window 3E now depicts the AMEX and or the American Stock Exchange's Big Board of Trades and or the AMEX's Main Table depicted formatted and or embedded within a SMTTFD type 2. The AMEX's Big Board of trades and or the American Stock Exchange's Main Table currently list approximately Five Hundred Seventy Six company's stock symbols along with each stock symbols current per share prices and the symbols daily change in price per share of stock. The Machine 1 Dissemination Center's Mainframe Computer Database server's search engine extracts all of these said mentioned Five Hundred and Seventy Six AMEX exchange listed stock symbols. This extracted list of Five Hundred Seventy Six exchange listed stock symbols is numbered and or sequenced One through Five Hundred Seventy Six in an A through Z, Alphabetical Order rotation cycle and or a SMTTFD type 2 for depiction (via wireless, digital radio transmissions) on the machine's viewing screen and or window 3E. This AMEX SMTTFD type 2 enables the “user” of the machine the ability, the means and the convenience to view, monitor and or track the AMEX Stock Exchange's complete listing of company stock symbols on the machine's viewing screen and or window 3E.

During Market Hours and or from a.m. 9:30 est., through and or until p.m. 4:00 est. time, the economic data and or the Five Hundred Seventy. Six AMEX exchange listed stock symbols along with each symbol's per share prices and the daily change in each symbol's per share prices, formatted and or embedded with color-coded symbols, letters and numbers will be updated with the current and or live and or real time values and or prices at the end of each Fifteen Minute rotation cycle. Note, the AMEX stock Exchange currently list approximately Five Hundred Seventy Six company's stock symbols, the Machine 1 and or the machine's viewing screen and or window 3E rotates and or scrolls within a Six Hundred Stock Symbol, Fifteen Minute rotation cycle, this leaves approximately Thirty Six Seconds of viewing and or display time unaccounted for This Thirty Six Second Time Frame of unaccounted for viewing and or display time will be utilized for Market updates and or breaking news events and or news headlines depicted as an ongoing String of characters.

During after Market Hours and or from p.m. 4:00 est., through and or until Opening Bell and or a.m. 9:30 est. time, this viewing'screen and or window 3E will not be affected nor will it be altered in any form and or manner by the activation of the Market Shift feature and or Mode 3. During the after Market Hours sessions the Machine 1 and or the machine's viewing screen and or window 3E depicts live Instanet Trading from the Instanet Trading Floor, formatted and or embedded within a SMTTFD type 1 that consist of a combination of the Top Six Hundred (according to Market Capitalization) NYSE Exchange listed stock symbols and the Top Six Hundred (according to Market Capitalization) NASDAQ Exchange listed stock symbols embedded side by side within the same string of characters. In retrospect these past few chapters tell the “user” of the machine how each of the machine's viewing screens and or windows 2C/2D and 3E have been affected and or altered in form and or function by the Market Shift feature and or Mode 3. What was not discussed nor mentioned was the machine's viewing screens and or windows 1A/1B, 3F and 4G. The plausible reasoning for this lack of discription is that nothing changes nor is anything altered in any way and or form concerning viewing screens and or windows 1A/1B, 3F and 4G by the Market Shift feature and or Mode 3.

In conclusion and or to summarize the machine's normal and or primary Mode of operation and or Mode 1 depicts SMTTFD type 1's on the machine's viewing screens and or window's 2C/2D and 3E during Market Hours. Once the Market Shift feature and or the Market Shift Mode of operation and or Mode 3 has been activated the machine's viewing screen and or window's 2C/2D and 3E will depict SMTTFD type 2's during Market Hours. During the after Market Hours sessions the Market Shift feature and or Mode 3 is not operational and or cannot be implemented until such time as when the Markets open once again for the business of trading shares of listed company's stock. The machine will remain in Mode 3 during Market Hours until such time as when the “user” of the machine programs the machine back into the normal and or primary mode of operation and or Mode 1.

Language Capabilities (Overview): Begin—

The Machine 1 and or the machine's viewing screen and or window 4G features a “user” of the machine's interface with the machine. This interface enables the “user” of the machine the ability, the means and the convenience to access the machine's language capabilities feature and or Mode of operation and or Mode 4. Mode 4 enables the “user” of the machine the unique ability, the means and the convenience to extract and or monitor any and or all of the machine's operational and or instructional and or Trading aids and or options in any One of Three languages. The machine 1 and or the machine's language capabilities feature and or Mode 4 features English as the official and or primary language, Spanish as a Secondary language and or French as as a Third linguistical choice. Note, once the Machine 1 and or the machine's Mode 4 has been activated and the primary language of English has been aborted for either the Secondary and or Third linguistical choices, the “user” of the machine will have to physically change the programming back to (in the same manner as before) Mode 1 if the “user” of the machine once again desires the machine's Instructional/programming aid to be depicted in the English language.

For demonstration purposes the “user” of the machine does not wish nor has no desire-to change the language of the machine. The “user” of the machine would merely like to peruse the listing of linguistical choices therefore—

Mode 4 of 4 of Operation: Begin—

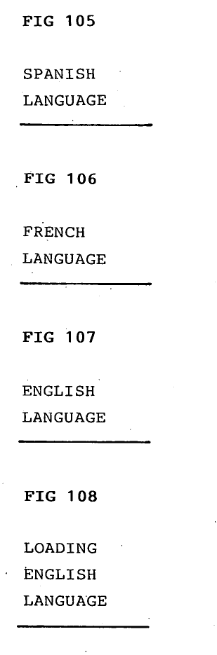

The “user” of the machine pushes the ON key then (SEE FIG. 039). FIG. 039 will be depicted on the machine's viewing screen and or window 4G for Three Seconds then (SEE FIG. 040). FIG. 040 will be depicted on the machine's viewing screen and or window 4G for Three Seconds then (SEE FIG. 041). FIG. 041 will be depicted on the machine's viewing screen and or window 4G for Three Seconds then (SEE FIG. 043-c). FIG. 043-C will be depicted on the machine's viewing screen and or window 4G. LANGUAGES BEGIN—Push the PRO key then (SEE FIG. 044). FIG. 044 will be depicted on the machine's viewing screen and or window 4G. COMMAND INSTRUCTION—the “user” of the machine enters and or types in the Four digit PIN #0000then (SEE FIG. 045). FIG. 045 will be depicted on the machine's viewing screen and or window 4G for Three Seconds then (SEE FIG. 046). FIG. 046 will be depicted on the machine's viewing screen and or window 4G. Push the MODE key then (SEE FIG. 086). FIG. 086 will be depicted on the machine's viewing screen and or window 4G. Push the MODE key then (SEE FIG. 100). FIG. 100 will be depicted on the machine's viewing screen and or window 4G. Push the MODE key then (SEE FIG. 104). FIG. 104 will be depicted on the machine's viewing'screen and or window 4G. Push the YES key then (SEE FIG. 105). FIG. 105 will be depicted on the machine's viewing screen and or window 4G. Push the NO key then (SEE FIG. 106). FIG. 106 will be depicted on the machine's viewing screen and or window 4G. Push the NO key then (SEE FIG. 107). FIG. 107 will be depicted on the machine's viewing screen and or window 4G. Push the YES key then (SEE FIG. 108). Note, the Machine 1 and or the machine is back to Mode 4, position 1, the English language. As said mentioned the “user” of the machine speaks English therefore—(SEE FIG. 108, reiterated), FIG. 108 will be depicted on the machine's viewing screen and or window 4G for Three Seconds then (SEE FIG. 043-C). FIG. 043-c will be depicted on the machine's viewing screen and or window 4G. Note, had the “user” of the machine chosen either the Spanish or French languages from this point forward all operating instructions and or Trading aids would be depicted in the selected language. If and when the “user” of the machine changes the depicted language from English into either Spanish and or French and then wants to change the language back to the English language then the “user” of the machine must do so in the same manner as before. This concludes the Machine 1 and or the machine's Instructional Guide.

.....end

Prelude to Claims: Begin—

Thomas Edison revolutionized the New York Stock Exchange by introducing several new patents pertaining to and or built upon the original stock market ticker tape. The Israeli Defence Department revolutionized modern day communication by developing and patenting Digital Messaging. The machine 1 and or the machine is built upon the foundation of the original stock market ticker tape. The machine is derived from the corner stone of digital messaging. This said mentioned foundation combined with the said mentioned corner stone are the roots from which the machine 1 and or the machine's claims are built upon and or are derived from. On this day I the inventor of the machine do hereby claim Twenty New improvements and or claims pertaining to and or built upon the original stock market ticker tape machine by utilizing digital messaging technology to and from a mobile, hand-held, wireless, digital radio transmitter/receiver and or the machine.

1- I the inventor do hereby claim that the machine is a mobile, hand-held, wireless digital radio transmitter/receiver specifically designed and or created to depict, illustrate and or display stock market ticker tapes embedded with live, real time and or dormant stock symbols listed with Three U.S. Stock Exchanges, the New York Stock Exchange, the NASDAQ stock Exchange and the American Stock Exchange, onto the machine's viewing screen thereby enabling the “user” of the machine the ability, the means and the convenience of having the stock Market in their pocket.

2- I the inventor do hereby claim that the machine is a mobile, hand-held, wireless digital radio transmitter/receiver that enables the “user” of the machine the ability, the means and the convenience to extract, monitor, track, set Limit Orders and Trade shares of stocks listed with the New York Stock Exchange, the NASDAQ Stock Exchange and the American Stock Exchange.

3- I the inventor do hereby claim that the machine is a mobile, hand-held, wireless digital radio transmitter/receiver that depicts live, real time and dormant world-wide economic data formatted and or embedded within digital color stock market ticker tapes and multiple catagory displays onto the machine's viewing screen, Twenty Four hours of each day and or Seven days of the week, ever after.

4- I the inventor do hereby claim that the machine is a mobile, hand-held, wireless digital radio transmitter/receiver that enables the “user” of the machine the ability, the means and the convenience to Trade (buy and or sell) shares of stocks with the Top Six Hundred Companies, (according to Market Capitalization), listed daily with the New York Stock Exchange, live and or in real time, Eastern time.
In addition to buying and or selling shares of company's stock the “user” of the machine can set and or Trade, (buy and or sell), Limit Order Stock Trades.

5- I the inventor do hereby claim that the machine is a mobile, hand-held, wireless digital radio transmitter/receiver that enables the “user” of the machine the ability, the means and the convenience to Trade (buy and or sell) shares of stocks with the Top Six Hundred Companies, (according to Market Capitalization), listed daily with the NASDAQ Stock Exchange, live and or in real time, Eastern time.
In addition to buying and or selling shares of company's stock the “user” of the machine can set and or Trade, (buy and or sell), Limit Order Stock Trades.

6- I the inventor do hereby claim that the machine is a mobile, hand-held, wireless digital radio transmitter/receiver that enables the “user” of the machine the ability, the means and the convenience to Trade (buy and or sell) shares of stocks with any and or all Exchange listed Stock Symbols, listed daily with the American Stock Exchange, live and or in real time, Eastern time.
In addition to buying and or selling shares of company's stocks the “user” of the machine can set and or Trade (buy and or sell) Limit Order Stock Trades.

7- I the inventor do hereby claim that the machine is a mobile, hand-held, wireless digital radio transmitter/receiver that enables the “user” of the machine the ability, the means and the convenience to extract and depict stock symbols embedded within live, real time and dormant color-coded stock market ticker tapes onto the machine's viewing screen, featuring the Top Six Hundred Companies, (according to Market Capitalization), listed daily with the New York Stock Exchange.

8- I the inventor do hereby claim that the machine is a mobile, hand-held, wireless digital radio transmitter/receiver that enables the “user” of the machine the ability, the means and the convenience to extract and depict stock symbols embedded within live, real time and dormant color-coded stock market ticker tapes onto the machine's viewing screen, featuring the Top Six Hundred Companies, (according to Market Capitalization), listed daily with the NASDAQ Stock Exchange.

9- I the inventor do hereby claim that the machine is a mobile, hand-held, wireless digital radio transmitter/receiver that enables the “user” of the machine the ability, the means and the convenience to extract and depict stock symbols embedded within live, real time and dormant color-coded stock market ticker tapes onto the machine's viewing screen, featuring any and or all of the stock symbols listed daily with the American Stock Exchange.

10- I the inventor do hereby claim that the machine is a mobile, hand-held, wireless digital radio transmitter/receiver that enables the “user” of the machine the ability, the means and the convenience to monitor stock symbols embedded within live, real time and dormant, color coded stock market ticker tapes displayed on the machine's viewing screen, featuring the Top Six Hundred Companies, (according to Market Capitalization), listed daily with the New York Stock Exchange.

11- I the inventor do hereby claim that the machine is a mobile, hand-held, wireless digital radio transmitter/receiver that enables the “user” of the machine the ability, the means and the convenience to monitor stock symbols embedded within live, real time and dormant, color coded stock market ticker tapes displayed on the machine's viewing screen, featuring the Top Six Hundred Companies, (according to Market Capitalization), listed daily with the NASDAQ Stock Exchange.

12- I the inventor do hereby claim that the machine is a mobile, hand-held, wireless digital radio transmitter/receiver that enables the “user” of the machine the ability, the means and the convenience to monitor stock symbols embedded within live, real time and dormant, color coded stock market ticker tapes displayed on the machine's viewing screen, featuring any and all of the company stock symbols listed daily with the American Stock Exchange.

13- I the inventor do hereby claim that the machine is a mobile, hand-held, wireless digital radio transmitter/receiver that enables the “user” of the machine the ability, the means and the convenience to both visually and electronically track stock symbols embedded within live, real time and dormant, color coded stock market ticker tapes displayed on the machine's viewing screen, featuring the Top Six Hundred companies, (according to Market Capitalization), listed daily with the New York Stock Exchange.

14- I the inventor do hereby claim that the machine is a mobile, hand-held, wireless digital radio transmitter/receiver that enables the “user” of the machine the ability, the means and the convenience to both visually and electronically track stock symbols embedded within live real time and dormant, color coded stock market ticker tapes displayed on the machine's viewing screen, featuring the Top Six Hundred companies, (according to Market Capitalization), listed daily with the NASDAQ Stock Exchange.

15- I the inventor do hereby claim that the machine is a mobile, hand-held, wireless digital radio transmitter/receiver that enables the “user” of the machine the ability, the means and the convenience to both visually and electronically track stock symbols embedded within live, real time and dormant, color coded stock market ticker tapes displayed on the machine's viewing screen, featuring any and or all company stock symbols listed daily with the American Stock Exchange.

16- I the inventor do hereby claim that the machine is a mobile, hand-held, wireless digital radio transmitter/receiver that enables the “user” of the machine the ability, the means and the convenience to extract, depict, monitor and track a combination of any and or all of the Top Six Hundred companies, (according to Market Capitalization), listed daily with the New York Stock Exchange along side of and or along with any and or all of the Top Six Hundred companies, (according to Market Capitalization), listed daily with the NASDAQ Stock Exchange.
Stock symbols from both said mentioned stock exchanges are depicted as listed, Buy Trades and or Sell Trades depicted side by side within a First come, First listed, live, real time, color coded stock market ticker tape, displayed on the machine's viewing screen.

17- I the inventor do hereby claim that the machine is a mobile, hand-held, wireless digital radio transmitter/receiver that enables the “user” of the machine the ability, the means and the convenience to extract, depict, monitor and track a combination of any and or all of the Top Six Hundred companies, (according to Market Capitalization), listed daily with the New York Stock Exchange along side of and or along with any and or all of the Top Six Hundred companies, (according to Market Capitalization), listed daily with the NASDAQ Stock Exchange along side of and or along with any and or all of the company stock symbols listed daily with the American Stock Exchange.
Stock symbols from any One and or all of the Three said mentioned stock exchanges are depicted in a pre-sequenced order within the “user” of the machine's Customized, Personal Portfolio, live, real time, and or dormant, color coded stock market ticker tapes featured on the machine's viewing screen.

18- I the inventor do hereby claim that the machine is a mobile, hand-held, wireless digital radio transmitter/receiver that enables the “user” of the machine the ability, the means and the convenience to extract, depict, monitor and track the Top Six Hundred companies, (according to Market Capitalization), listed daily with the New York Stock Exchange, embedded within Six types of live, real time and dormant, color coded stock market ticker tapes, type 1, type 2, type 3, type 4, type 5 and type 6, featured and or displayed on the machine's viewing screen.
(SEE (SMTTFD) Stock Market Ticker Tape Formatted displays, types One through Six, descriptive).

19- I the inventor do hereby claim that the machine is a mobile, hand-held, wireless digital radio transmitter/receiver that enables the “user” of the machine the ability, the means and the convenience to extract, depict, monitor and track the Top Six Hundred companies, (according to Market Capitalization), listed daily with the NASDAQ Stock Exchange, embedded within Six types of live, real time and dormant, color coded stock market ticker tapes, type 1, type 2, type 3, type 4, type 5 and type 6, featured and or displayed on the machine's viewing screen.
(SEE (SMTTFD) Stock Market Ticker Tape Formatted displays, types One through Six, descriptive).

20- I the inventor do hereby claim that the machine is a mobile, hand-held, wireless digital radio transmitter/receiver that enables the “user” of the machine the ability, the means and the convenience to extract, depict, monitor and track the Top Six Hundred companies, (according to Market Capitalization), listed daily with the American Stock Exchange, embedded within Six types of live, real time and dormant, color coded stock market ticker tapes, type 1, type 2, type 3, type 4, type 5 and type 6, featured and or displayed on the machine's viewing screen.
(SEE (SMTTFD) Stock Market Ticker Tape Formatted displays, types One through Six, descriptive).
